(19) United States
(12) Patent Application Publication
(10) Pub. No.: US 2026/0255209 A1
(43) Pub. Date: Aug. 27, 2026

(54) Communication Method and Related Products

(71) Applicant: HUAWEI TECHNOLOGIES CO., LTD., Shenzhen (CN)

(72) Inventors: Rojan Chitrakar, Singapore (SG); Bin Qian, Shenzhen (CN); Lei Huang, Singapore (SG); Xun Yang, Singapore (SG)

(73) Assignee: HUAWEI TECHNOLOGIES CO., LTD., Shenzhen (CN)

(21) Appl. No.: 19/656,699

(22) Filed: Apr. 23, 2026

Related U.S. Application Data
(63) Continuation of application No. PCT/CN2023/126305, filed on Oct. 24, 2023.

(51) Int. Cl. H04W 24/10; H04B 17/318

(52) U.S. Cl. CPC H04W 24/10; H04B 17/328

(57) ABSTRACT

A communication method includes a responder receiving at least one first sensing packet from an initiator, and transmitting at least one first measurement report frame according to the at least one first sensing packet, where the at least one first measurement report frame is used to provide a result of first measurement performed by the responder on the at least one first sensing packet, and a respective first measurement report frame of the at least one first measurement report frame is indicative of an identification of the respective first measurement report frame and the first measurement to which the at least one first sensing packet belongs.

### CROSS-REFERENCE TO RELATED APPLICATIONS

This is a continuation of International Patent Application No. PCT/CN2023/126305 filed on Oct. 24, 2023, which is hereby incorporated by reference in its entirety.

### TECHNICAL FIELD

The present disclosure relates to the field of communication technologies, and in particular, to a communication method and related products.

### BACKGROUND

Ultra-wideband (UWB) technology is increasingly being used for indoor positioning and other location services such as access control and asset locating. Aside from dedicated devices and tags, UWB radios are becoming increasingly common in high end smartphones.

Aside from the ranging use case, other use cases such as device free sensing, downlink time difference of arrival (DL-TDOA), long-range ranging, etc. are being actively investigated. An UWB device that supports sensing is called a sensing-capable device (SDEV). Sensing involves the use of UWB transmissions to obtain measurements to estimate features such as range, velocity, and motion of objects in an area of interest. Sensing measurements can enable various applications such as presence detection and environmental mapping.

This background information is provided to reveal information believed by the applicant to be of possible relevance to the present disclosure. No admission is necessarily intended, nor should be construed, that any of the preceding information constitutes prior art against the present disclosure.

### SUMMARY

In a first aspect, an embodiment of the present disclosure provides a wireless communication method, the method being applied for ultra-wideband sensing, where the method includes receiving, by a responder, at least one first sensing packet from an initiator; and transmitting, by the responder, at least one first measurement report frame according to the at least one first sensing packet, where the at least one first measurement report frame is used to provide a result of first measurement performed by the responder on the at least one first sensing packet, and a respective first measurement report frame of the at least one first measurement report frame is indicative of an identification of the respective first measurement report frame and the first measurement to which the at least one first sensing packet belongs.

In this way, the initiator is enabled to identify measurement report frames from the responder, and could thus arrange these measurement report frames in a right order, thus improving the accuracy of the measurement.

In a possible implementation of the first aspect, the respective first measurement report frame includes a report number for indicating the identification of the first measurement report frame and a measurement number for identifying the first measurement to which the at least one first sensing packet belongs.

Since the measurement report frame carries the report number and measurement number to identify the partial report, so that partial report corresponding a specific receive antenna and segment pair on a particular channel can be accurately identified.

In a possible implementation of the first aspect, the at least one first sensing packet includes one or more segments, and the respective first measurement report frame includes at least one partial report; where a respective partial report of the at least one partial report corresponds to a first reporting set of a segment of the at least one first sensing packet and an antenna of the responder for receiving the segment.

Since the first measurement report frame may be divided into two or more partial reports, each partial report carrying all channel impulse response (CIR) taps corresponding to a receive antenna and segment pair; so that the partial report allows the measurement report to be divided into smaller components, each component carrying a complete set of CIR taps for a receive antenna and segment pair. Even if some components are not received, the remaining received components can still be parsed, allowing partial sensing measurements to be obtained.

In a possible implementation of the first aspect, the respective partial report corresponds to a second reporting set of the segment of the at least one first sensing packet, the antenna of the responder for receiving the segment and a first channel on which the segment is transmitted by the initiator.

Similarly, since the first measurement report frame may be divided into two or more partial reports, each partial report carrying all the CIR taps corresponding to a receive antenna and segment pair on a particular channel; so that the partial report allows the measurement report to be divided into smaller components, each component carrying a complete set of CIR taps for a receive antenna and segment pair. Even if some components are not received, the remaining received components can still be parsed, allowing partial sensing measurements to be obtained.

In a possible implementation of the first aspect, the respective partial report is indicative of the second reporting set corresponding to the respective partial report.

Based on the second reporting set, the respective partial report corresponding a specific receive antenna and segment pair on a particular channel can be accurately identified.

In a possible implementation of the first aspect, the respective partial report includes a segment identifier for identifying the segment in the second reporting set corresponding to the respective partial report, an antenna identifier for identifying the antenna in the second reporting set corresponding to the respective partial report and a channel identifier for identifying the first channel in the second reporting set corresponding to the respective partial report.

Similarly, the respective partial report can be accurately identified based on the segment identifier, antenna identifier, and channel identifier.

In a possible implementation of the first aspect, the respective first measurement report frame further includes a first report field for indicating whether the segment identifier, the antenna identifier and the channel identifier are present.

The initiator may quickly determine whether these fields exist based on the first report field, without decoding the actual fields carrying the segment identifier, the antenna identifier, and the channel identifier.

In a possible implementation of the first aspect, the channel identifier is a relative index of the first channel on which the segment is transmitted by the initiator.

Since the channel identifier is a relative index, signaling overhead would be reduced when identifying the channel for transmitting the packet.

In a possible implementation of the first aspect, the respective first measurement report frame includes a segment bitmap for identifying the segment in the second reporting set corresponding to the respective partial report, an antenna bitmap for identifying the antenna in the second reporting set corresponding to the respective partial report and a channel bitmap for identifying the channel in the second reporting set corresponding to the respective partial report.

Since the first measurement report frame may be divided into two or more partial reports, each partial report carrying all the CIR taps corresponding to a receive antenna and segment pair; so that the partial report allows the measurement report to be divided into smaller components, each component carrying a complete set of CIR taps for a receive antenna and segment pair. Even if some components are not received, the remaining received components can still be parsed, allowing partial sensing measurements to be obtained based on the bitmaps.

In a possible implementation of the first aspect, the respective first measurement report frame further includes a second report field for indicating whether the segment bitmap, the antenna bitmap and the channel bitmap are present.

The initiator may quickly determine whether these bitmaps exist based on the first report field, without decoding the actual fields carrying these bitmaps.

In a possible implementation of the first aspect, the at least one partial report includes multiple partial reports, and the multiple partial reports are arranged in a preset order.

Since the multiple partial reports are arranged in a preset order, a particular partial report may be accurately identified and signaling overhead may be reduced.

In a possible implementation of the first aspect, where the at least one first sensing packet includes one first sensing packet and the one first sensing packet includes a first preset number of segments; where the at least one first measurement report frame includes multiple measurement report frames, and a number of the multiple measurement report frames is equal to the first preset number; or, where the at least one first measurement report frame includes one measurement report frame.

Based on this, it can be seen that the communication method may be applied to various forms of transmission packets and the measurement report frames.

In a possible implementation of the first aspect, the first preset number of segments are transmitted on different channels.

Based on this, it can be seen that the segments may be flexible transmitted in different channels.

In a possible implementation of the first aspect, the at least one first sensing packet includes multiple sensing packets, and the multiple sensing packets are transmitted on different channels, each of the multiple sensing packets includes one or more segments; where segments of a same sensing packet are transmitted on a same channel, or, segments of a same sensing packet are transmitted on different channels.

Based on this, it can be seen that the sensing packets and the segments may be flexible transmitted in different channels.

In a possible implementation of the first aspect, the at least one first measurement report frame includes multiple measurement report frames, and a number of the multiple sensing packets is the same as a number of the multiple measurement report frames.

Based on this, it can be seen that the number of the measurement report frame may be flexibly set based on the number of the transmission sensing packet.

In a possible implementation of the first aspect, in a case where the segments of the same sensing packet are transmitted on the same channel, the at least one first measurement report frame includes one measurement report frame, and the one measurement report frame is indicative of the first reporting set corresponding to the respective partial report, where measurements for each segment are reported for aggregation of the different channels on which the multiple sensing packets are transmitted.

The transmission of multiple sensing packets for implementing the same measurement purpose (sensing task) would be beneficial in the case where the number of segments is limited, for example when the number of segments is lesser than the number of channels to be aggregated.

In a possible implementation of the first aspect, the respective first measurement report frame is further indicative of a first reference tap timestamp for all of the at least one partial report.

Since the reference tap of one partial report is chosen as the first reference tap timestamp (common reference tap timestamp) and signaled in the first reference tap timestamp field, and combined with the offset with respect to the chosen common reference tap timestamp, the reference tap timestamp in the CIR report is signaled, thereby reducing the signaling overhead.

In a possible implementation of the first aspect, the respective first measurement report frame includes a first reference tap timestamp field for indicating the first reference tap timestamp.

Similarly, since the reference tap of one partial report is chosen as the first reference tap timestamp (common reference tap timestamp) and signaled in the first reference tap timestamp field, and combined with the offset with respect to the chosen common reference tap timestamp, the reference tap timestamp in the CIR report is signaled, thereby reducing the signaling overhead.

In a possible implementation of the first aspect, the respective first measurement report frame further includes a third report field for indicating whether the first reference tap timestamp field is present.

Based on the third report field, the initiator may quickly know whether the first reference tap timestamp field is present, without decoding the actual fields carrying the first reference tap timestamp field.

In a possible implementation of the first aspect, the respective partial report is indicative of an offset between the first reference tap timestamp and a second reference tap timestamp for the respective partial report.

Similarly, since the reference tap of one partial report is chosen as the first reference tap timestamp (common reference tap timestamp) and signaled in the first reference tap timestamp field, and combined with the offset with respect to the chosen common reference tap timestamp, the reference tap timestamp in the CIR report is signaled, thereby reducing the signaling overhead.

In a possible implementation of the first aspect, the respective partial report includes an offset field for indicating the offset between the first reference tap timestamp and the second reference tap timestamp for the respective partial report.

Similarly, since the reference tap of one partial report is chosen as the first reference tap timestamp (common reference tap timestamp) and signaled in the first reference tap timestamp field, and combined with the offset with respect to the chosen common reference tap timestamp, the reference tap timestamp in the CIR report is signaled, thereby reducing the signaling overhead.

In a possible implementation of the first aspect, the respective partial report further includes a fourth report field for indicating whether the offset field is present.

Based on the fourth report field, the initiator may quickly know whether the offset field is present, without decoding the actual fields carrying the offset field.

In a possible implementation of the first aspect, the respective partial report is indicative of a second reference tap timestamp for the respective partial report.

In a possible implementation of the first aspect, the respective partial report includes a second reference tap timestamp field for indicating the second reference tap timestamp for the respective partial report.

In a possible implementation of the first aspect, the respective partial report further includes a fifth report field for indicating whether the second reference tap timestamp field is present.

In a possible implementation of the first aspect, a first measurement report frame of the at least one first measurement report frame is indicative of a first parameter for all partial reports carried in the at least one first measurement report frame, and indications for the first parameter are omitted in remaining measurement report frames other than the first measurement report frame.

Since the measurement report may include multiple partial reports, and the first parameter may be parameters common to all partial reports carried in the at least one first measurement report frame, that is, the at least one first measurement report frame used for carrying all the partial reports share the first parameter, so it is possible to simply carry the first parameter in the first measurement report frame of the at least one first measurement report frame, and omit indications for the first parameter in other measurement report frames, so as to reduce the signaling overhead.

In a possible implementation of the first aspect, the respective first measurement report frame is further indicative of an address of the responder.

In a possible implementation of the first aspect, the respective first measurement report frame includes an address identifier for identifying the address of the responder.

In a possible implementation of the first aspect, the respective first measurement report frame further includes a sixth report field for indicating whether the address identifier is present.

In a possible implementation of the first aspect, a first sensing packet in the at least one first sensing packet includes multiple segments, and the multiple segments are transmitted in a sequential manner or an out-of-sequence manner.

In a possible implementation of the first aspect, the method further includes receiving, by the responder, a sensing session setup request message from the initiator, where the sensing session setup request message is indicative of a second channel for transmitting the at least one first measurement report frame; and transmitting, by the responder, a sensing session setup response message to the initiator according to the sensing session setup request message; where transmitting, by the responder, the at least one first measurement report frame according to the at least one sensing packet includes transmitting, by the responder, the at least one first measurement report frame according to the at least one sensing packet over the second channel.

In a possible implementation of the first aspect, the sensing session setup request message is further indicative of a time requirement between two overlapped segments of a sensing packet or two overlapped sensing packets.

In a second aspect, an embodiment of the present disclosure provides a communication method, the method being applied for ultra-wideband sensing, where the method includes transmitting, by an initiator, at least one first sensing packet to a responder; and receiving, by the initiator, at least one first measurement report frame from the responder, where the at least one first measurement report frame is used to provide a result of first measurement carried by the responder on the at least one first sensing packet, and a respective first measurement report frame of the at least one first measurement report frame is indicative of the respective first measurement report frame and the first measurement to which the at least one first sensing packet belongs.

In a possible implementation of the second aspect, the method further includes transmitting, by the initiator, a sensing session setup request message to the responder, where the sensing session setup request message is indicative of a second channel for transmitting the at least one first measurement report frame; and receiving, by the initiator, a sensing session setup response message from the responder, where the sensing session setup response message is determined by the responder according to the sensing session setup request message.

In a possible implementation of the second aspect, the sensing session setup request message is further indicative of a time requirement between two overlapped segments of a first sensing packet or two overlapped first sensing packets.

In a possible implementation of the second aspect, the method further includes transmitting, by the initiator, at least one second sensing packet to a further responder; and receiving, by the initiator, at least one second measurement report frame from the further responder, where the at least one second measurement report frame is used to provide a result of second measurement carried by the further responder on the at least one second sensing packet, and a respective second measurement report frame of the at least one second measurement report frame is indicative of the respective second measurement report frame and the second measurement to which the at least one second sensing packet belongs.

In a possible implementation of the second aspect, the method further includes forwarding, by the initiator, the at least one first measurement report frame and/or the at least one second measurement report frame to a sensing requesting device.

In a possible implementation of the second aspect, forwarding, by the initiator, the at least one first measurement report frame and/or the at least one second measurement report frame to the sensing requesting device includes: for each of the at least one first measurement report frame and/or the at least one second measurement report frame, processing, by the initiator, the measurement report frame to meet an address requirement, where the address requirement includes a measurement report frame carrying an address of a responder transmitting the measurement report frame, where the address of the responder is readable by the sensing requesting device; and forwarding, by the initiator, the processed measurement report frame to a sensing requesting device.

In order to reduce overhead, the address of the responder indicated by the measurement report frame may be a short address, this short address is readable by the initiator but is unreadable by the sensing requesting device, so the initiator needs to replace such short address with an extended address which could be read by the sensing requesting device. In another case, the responder address field may also be omitted, that is, there is no Responder Address field in the measurement report frame from the responder, then in this case, the initiator would have to add the extended address of the responder so as to let the sensing requesting device knows the address of the responder. Therefore, the initiator may process the received measurement report frame (the at least one first measurement report frame and the at least one second measurement report frame) so as to ensure that they meet the above address requirement.

In a possible implementation of the second aspect, processing, by the initiator, the measurement report frame to meet an address requirement includes: in a case that the measurement report frame does not carry a first address, adding, by the initiator, a second address to the first measurement report frame; and in a case that the measurement report frame carries the first address, replacing, by the initiator, the first address with the second address; where the first address and the second address are addresses of a responder transmitting the measurement report frame, the first address is unreadable by the sensing requesting device and the second address is readable by the sensing requesting device.

In a third aspect, an embodiment of the present disclosure provides a wireless communication apparatus, including various modules configured to execute the wireless communication method according to the first aspect or any possible implementation of the first aspect.

In a fourth aspect, an embodiment of the present disclosure provides a wireless communication apparatus, including various modules configured to execute the wireless communication method according to the second aspect or any possible implementation of the second aspect.

In a fifth aspect, an embodiment of the present disclosure provides a terminal device including processing circuitry for executing the wireless communication method according to the first aspect or any possible implementation of the first aspect.

In a sixth aspect, an embodiment of the present disclosure provides a network device including processing circuitry for executing the wireless communication method according to the second aspect or any possible implementation of the second aspect.

In a seventh aspect, an embodiment of the present disclosure provides a computer-readable medium storing computer execution instructions which, when executed by a processor, causes the processor to execute the wireless communication method according to the first aspect or any possible implementation of the first aspect.

In an eighth aspect, an embodiment of the present disclosure provides a computer-readable medium storing computer execution instructions which, when executed by a processor, causes the processor to execute the wireless communication method according to the second aspect or any possible implementation of the second aspect.

In a ninth aspect, an embodiment of the present disclosure provides a wireless communication system, including the terminal device according to the fifth aspect and the network device according to the sixth aspect.

In a tenth aspect, an embodiment of the present disclosure provides a computer program product including computer execution instructions which, when executed by a processor, causes the processor to execute the wireless communication method according to the first aspect or any possible implementation of the first aspect or according to the second aspect or any possible implementation of the second aspect.

In the communication method according to the present disclosure, a responder receives at least one first sensing packet from an initiator, and transmits at least one first measurement report frame according to the at least one first sensing packet, where the at least one first measurement report frame is used to provide a result of first measurement performed by the responder on the at least one first sensing packet, and a respective first measurement report frame of the at least one first measurement report frame is indicative of an identification of the respective first measurement report frame and the first measurement to which the at least one first sensing packet belongs. In this way, the initiator is enabled to identify measurement report frames from the responder, and could thus arrange these measurement report frames in a right order, thus improving the accuracy of the measurement.

### BRIEF DESCRIPTION OF DRAWINGS

Reference will now be made, by way of example, to the accompanying drawings which show example embodiments of the present disclosure.

FIG. 1 is a simplified schematic illustration of a communication system according to one or more embodiments of the present disclosure.

FIG. 2 is a schematic illustration of an example communication system according to one or more embodiments of the present disclosure.

FIG. 3 is a schematic illustration of a basic component structure of a communication system according to one or more embodiments of the present disclosure.

FIG. 4 illustrates a block diagram of a device in a communication system according to one or more embodiments of the present disclosure.

FIG. 5 is a schematic diagram of a Receive Report field of a measurement report frame according to one or more embodiments of the present disclosure.

FIG. 6A is a schematic flowchart of a communication method according to one or more embodiments of the present disclosure.

FIG. 6B is a possible implementation corresponding to the process shown in FIG. 6A.

FIG. 7 is a schematic diagram of an AC information element (IE) field of a sensing session setup request message according to one or more embodiments of the present disclosure.

FIG. 8 is a schematic diagram of a measurement report frame according to one or more embodiments of the present disclosure.

FIG. 9 is a schematic diagram of a CIR report IE content field of a measurement report frame according to one or more embodiments of the present disclosure.

FIG. 10 is a schematic diagram of another CIR report IE content field of a measurement report frame according to one or more embodiments of the present disclosure.

FIG. 11 is a schematic diagram of a processed target feature IE content field of a measurement report frame according to one or more embodiments of the present disclosure.

FIG. 12A to FIG. 12D are schematic diagrams of two ways for signaling a reference tap in the CIR report according to one or more embodiments of the present disclosure.

FIG. 13 is a schematic diagram of an interaction process between an initiator and a responder according to one or more embodiments of the present disclosure.

FIG. 14 is a schematic diagram of another interaction process between an initiator and a responder according to one or more embodiments of the present disclosure.

FIG. 15 is a schematic diagram of another interaction process between an initiator and a responder according to one or more embodiments of the present disclosure.

FIG. 16 is a schematic diagram of another interaction process between an initiator and a responder according to one or more embodiments of the present disclosure.

FIG. 17 is a schematic diagram of a measurement report frame of the interaction process shown in FIG. 15.

FIG. 18 is a schematic diagram of a measurement report frame of the interaction process shown in FIG. 15 using the format of the CIR report IE content field shown in FIG. 10.

FIG. 19 is a schematic diagram of another interaction process between an initiator and a responder according to one or more embodiments of the present disclosure.

FIG. 20 is a schematic diagram of another interaction process between an initiator and a responder according to one or more embodiments of the present disclosure.

FIG. 21A is a schematic flowchart of another communication method according to one or more embodiments of the present disclosure.

FIG. 21B is a possible implementation corresponding to the process shown in FIG. 21A.

FIG. 22 is a schematic diagram of a measurement report frame of the interaction process shown in FIG. 21B.

FIG. 23 is a schematic structural diagram of a wireless communication apparatus according to one or more embodiments of the present disclosure.

FIG. 24 is a schematic structural diagram of another wireless communication apparatus according to one or more embodiments of the present disclosure.

### DESCRIPTION OF EMBODIMENTS

To describe the technical solutions in embodiments of the present disclosure more clearly, the following briefly introduces the accompanying drawings needed for describing the embodiments.

In the following description, reference is made to the accompanying figures, which form part of the present disclosure, and which show, by way of illustration, specific aspects of embodiments of the present disclosure or specific aspects in which embodiments of the present disclosure may be used. It is understood that embodiments of the present disclosure may be used in other aspects and include structural or logical changes not depicted in the figures. The following detailed description, therefore, is not to be taken in a limiting sense, and the scope of the present disclosure is defined by the appended claims.

To assist in understanding the present disclosure, examples of wireless communication systems and devices are described below.

### Example Communication Systems and Devices

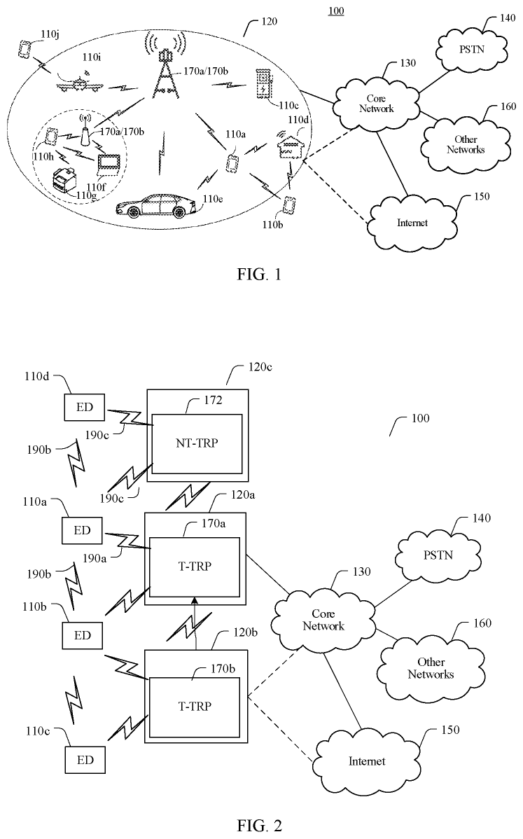

Referring to FIG. 1, as an illustrative example without limitation, a simplified schematic illustration of a communication system is provided. The communication system 100 includes a radio access network 120. The radio access network 120 may be a next generation (e.g., sixth generation (6G) or later) radio access network, or a legacy (e.g., fifth generation (5G), fourth generation (4G), third generation (3G), or second generation (2G) radio access network, or a wireless local area network (WLAN) (e.g., based on 802.11). One or more communication electric device (ED) 110a-110j (generically referred to as 110) may be interconnected to one another or connected to one or more network nodes (170a, 170b, generically referred to as 170) in the radio access network 120. One or more EDs 110a-110j also comprise UWB modules and are capable of performing sensing of the surrounding environment using UWB signals. A core network 130 may be a part of the communication system and may be dependent or independent of the radio access technology used in the communication system 100. Also, the communication system 100 includes a public switched telephone network (PSTN) 140, the Internet 150, and other networks 160.

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery, and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network including multiple layers. Compared to other communication networks, the heterogeneous network may achieve better overall performance through efficient multi-link joint operation, more flexible functionality sharing, and faster physical layer link switching between terrestrial networks and non-terrestrial networks. In the simplest form the communication system 100 may even be just a single ED that can perform mono-static sensing of the surrounding environment, or a pair of EDs that can engage in bi-static sensing of the surrounding environment, or three or more EDs that can engage in multi-static sensing of the surrounding environment.

The terrestrial communication system and the non-terrestrial communication system could be considered sub-systems of the communication system. In the example shown, the communication system 100 includes ED 110a-110d (generically referred to as ED 110), radio access networks (RANs) 120a-120b, non-terrestrial communication network 120c, a core network 130, a PSTN 140, the Internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code-division multiple access (CDMA), time-division multiple access (TDMA), frequency-division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. In some examples, the link is a dedicated connection for unicast transmission, a connection for broadcast transmission, or a connection between a group of EDs and one or multiple NT-TRPs for multicast transmission.

The air interfaces 190a, 190b and 190c may also use UWB technology to perform sensing of the surrounding environment using UWB signals.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

### Basic Component Structure

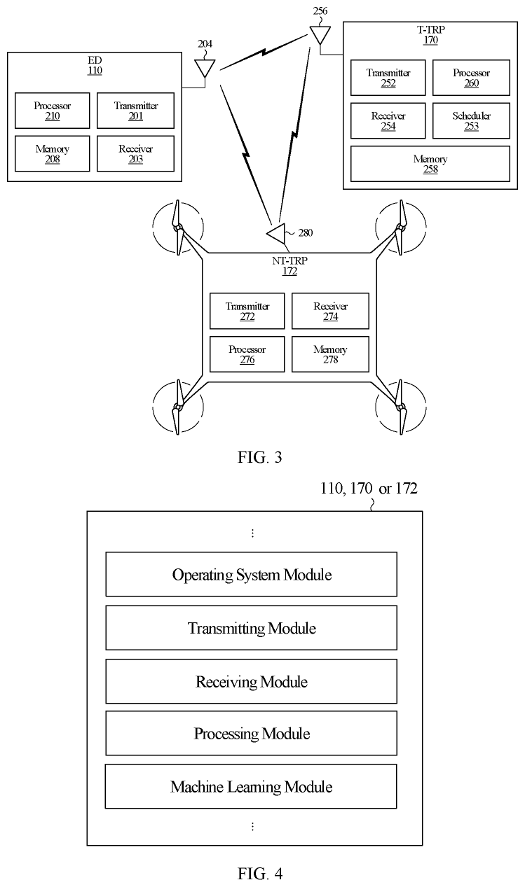

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle-to-everything (V2X), peer-to-peer (P2P), machine-to-machine (M2M), machine-type communications (MTC), Internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices as a user equipment/device (UE), a wireless transmit/receive unit (WTRU), a mobile station, a fixed or mobile subscriber unit, a cellular telephone, a station (STA), an MTC device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g., as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random-access memory (RAM), read-only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding, and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as an FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

### Basic Module Structure

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

### Air Interface

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s), and/or modulation scheme(s) for conveying information (e.g. data) over a wireless communications link. The wireless communications link may support a link between a radio access network and user equipment (e.g. a “Uu” link), and/or the wireless communications link may support a link between device and device, such as between two user equipments (e.g., a “sidelink”), and/or the wireless communications link may support a link between a non-terrestrial (NT)-communication network and UE. The air interfaces may also use UWB technology to perform sensing of the surrounding environment using UWB signals.

The followings are some examples for the above components:

A waveform component may specify a shape and form of a signal being transmitted. Waveform options may include orthogonal multiple access waveforms and non-orthogonal multiple access waveforms. Non-limiting examples of such waveform options include orthogonal frequency-division multiplexing (OFDM), filtered OFDM (f-OFDM), time windowing OFDM, filter bank multicarrier (FBMC), universal filtered multicarrier (UFMC), generalized frequency-division multiplexing (GFDM), wavelet packet modulation (WPM), faster than Nyquist (FTN) waveform, high rate pulse repetition frequency (HRP) UWB waveform, low rate pulse repetition frequency (LRP) UWB waveform and low peak-to-average power ratio waveform (low PAPR WF).

A frame structure component may specify a configuration of a frame or group of frames. The frame structure component may indicate one or more of a time, frequency, pilot signature, code, or other parameter of the frame or group of frames. More details of frame structure will be discussed below.

A multiple access scheme component may specify multiple access technique options, including technologies defining how communicating devices share a common physical channel, such as TDMA, FDMA, CDMA, SC-FDMA, low density signature multicarrier CDMA (LDS-MC-CDMA), non-orthogonal multiple access (NOMA), pattern division multiple access (PDMA), lattice partition multiple access (LPMA), resource spread multiple access (RSMA), and sparse code multiple access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources, and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all concept”. For example, the components within the air interface cannot be changed or adapted once the air interface is defined. In some implementations, only limited parameters or modes of an air interface, such as a cyclic prefix (CP) length or a MIMO mode, can be configured. In some embodiments, an air interface design may provide a unified or flexible framework to support below 6 gigahertz (GHz) and beyond 6 GHz frequencies (e.g., millimeter-wave (mmWave)) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible radio access network (RAN) slicing through channel resource sharing between different services in both frequency and time.

### Terminal Types

The data processing method provided in the embodiment of the present disclosure may be applied to various communication scenarios, for example, may be applied to one or more of the following communication scenarios: enhanced mobile broadband (eMBB), ultra-reliable low-latency communication (URLLC), MTC, IoT, narrowband IoT (NB-IoT), customer premises equipment (CPE), AR, VR, mass MTC (mMTC), D2D, V2X, V2V, etc.

It should be noted that in the embodiment of the present disclosure, IoT may include one or more of NB-IoT, MTC, mMTC, and the like. This is not limited.

The eMBB may be a large-traffic mobile broadband service such as a three-dimensional (3D) or ultra-high-definition video. Further, the eMBB may further improve performance such as a network speed and user experience based on a mobile broadband service. For example, when a user watches a 4K high definition (HD) video, the peak network speed can reach 10 Gbit/s.

URLLC may refer to a service with high reliability, low latency, and extremely high availability. Specifically, the URLLC may include the following communications scenarios and applications: industrial application and control, traffic safety and control, remote manufacturing, remote training, remote surgery, unmanned driving, industrial automation, a security industry, and the like.

MTC may refer to a low-cost and coverage-enhanced service, and may also be referred to as M2M. mMTC refers to large-scale IoT services.

NB-IoT may be a service that features wide coverage, a large number of connections, a low rate, a low cost, low power consumption, and an excellent architecture. Further, the NB-IoT may include a smart water meter, smart parking, intelligent pet tracking, a smart bicycle, an intelligent smoke detector, an intelligent toilet, an intelligent vending machine, and the like.

The CPE may refer to a mobile signal access device that receives a mobile signal and forwards the mobile signal by using a WiFi signal, or may refer to a device that converts a high-speed 4G or 5G signal into a WiFi signal, and may simultaneously support a relatively large quantity of mobile terminals that access the Internet. CPEs can be widely used for wireless network access in rural areas, towns, hospitals, units, factories, and residential areas, reducing the cost of laying wired networks.

The V2X can enable communication between vehicles, between vehicles and network devices, and between network devices, to obtain a series of traffic information such as a real-time road condition, road information, and pedestrian information, and provide in-vehicle entertainment information to improve driving safety, reduce congestion, and improve traffic efficiency.

For example, the terminal type includes an eMBB device, a URLLC device, an NB-IoT device, and a CPE device. The eMBB device is mainly configured to transmit large-packet data, or may be configured to transmit small-packet data, and is generally in a moving state. Requirements for a transmission delay and reliability are general, and both uplink and downlink communication exists. A channel environment is relatively complex and changeable, and indoor communication or outdoor communication may be used. For example, an eMBB device may be a mobile phone. The URLLC device is mainly configured to transmit small packet data, or may transmit medium packet data. Generally, the URLLC device belongs to a non-moving state, or may move along a fixed route. The URLLC device has a relatively high requirement for a transmission delay and reliability, that is, a low transmission delay and high reliability are required, and both uplink and downlink communications have. The channel environment is stable. For example, the URLLC device may be a factory device. The NB-IoT device is mainly used to transmit small data. The NB-IoT device is generally in a non-moving state, has a known location, has a medium transmission delay and reliability requirement, has a relatively large amount of uplink communication, and has a relatively stable channel environment. For example, the NB-IoT device may be a smart water meter or a sensor. The CPE device is mainly used to transmit large-packet data, is generally in a non-mobile state, or can move over ultra-short distances, has medium requirements on transmission delay and reliability, has both uplink and downlink communication, and has a relatively stable channel environment. For example, The CPE device may be a terminal device, an AR, a VR, or the like in the smart home. When the terminal type of the terminal device is determined, the terminal type may be determined based on a service type, mobility, a transmission delay requirement, a reliability requirement, a channel environment, and a communication scenario of the terminal device. Determining that the terminal type corresponding to the terminal device is an eMBB device, a URLLC device, an NB-IoT device, or a CPE device.

As described in the related art, UWB technology is increasingly being used for indoor positioning and other location services such as access control and asset locating. Aside from dedicated devices and tags, UWB radios are becoming increasingly common in high end smartphones.

Aside from the ranging use case, other use cases such as device free sensing, DL-TDOA, long range ranging etc. are being actively investigated. An UWB device that supports sensing is called a SDEV. Sensing involves the use of UWB transmissions to obtain measurements to estimate features such as range, velocity, and motion of objects in an area of interest. Sensing measurements can enable various applications such as presence detection and environmental mapping.

Based on its role during the sensing measurements, an SDEV may assume any one or more of the following roles:
controller: an SDEV that controls the sensing session and defines the sensing parameters;
controlee: an SDEV that utilizes the sensing parameters received from the controller; sensing initiator: an SDEV that initiates a sensing session with other SDEVs, which could also be referred to as an initiator, where the sensing session may be from a time point where the initiator transmits a session setup request message to a time point where the initiator receives reports of all measurement instances from a responder, the sensing session may include one or more sensing measurement instances, one measurement instance represents the measurement(s) performed for one purpose (corresponding to the same sensing task), for example, in order to measure the channel condition of one or more channels, the initiator would send one or more channel sounding PHY protocol data units (PPDU) to the responder, and the responder may measure the one or more PPDUs (e.g., measure one or more segments of each PPDU) and reports the result of the measurement(s), such measurement(s) would be regarded as one measurement instance;
sensing responder: an SDEV that participates in a sensing session initiated by an initiator, which is also referred to as a responder;
sensing transmitter: an SDEV that transmits a channel sounding PHY PPDU to be used for performing the sensing measurements, which is also referred to as a transmitter, and the channel sounding PPDU can also be referred to as a sensing PPDU or a sensing packet, including one or more segments;
sensing receiver: an SDEV that receives the channel sounding PPDU and performs the sensing measurements, which is also referred to as a receiver;
sensing requesting device: an SDEV that requests another SDEV to perform the sensing measurements in a proxy application.

The initiator may be the transmitter or the receiver, when the initiator is the transmitter, the responder is the receiver, and vice versa. In the following description, an example where the initiator is the transmitter and the responder is the receiver would be taken to illustrate the technical solution of the present disclosure, but it should be understood that the solution of the present disclosure is also applicable for the case where the initiator is the receiver, and the responder is the transmitter.

In most sensing scenarios, the sensing application runs on the initiator. When the initiator is the sensing transmitter and transmits the sensing packet (e.g., PPDU) to the responder, the responder (sensing receiver) may send an over-the-air (OTA) sensing measurement report including one or more (sensing) measurement report frames carrying the results of the sensing measurements to the initiator. Two types of sensing measurement reports are supported as follows.
1) Windows-based (CIR) report

The sensing measurement report carries the CIR taps measured within a certain time window.
2) Processed target features report

The sensing measurement report carries the processed report for sensing such as angle of arrival (AoA), range, velocity, radar cross section (RCS) etc.

For sensing applications, using wider channel bandwidth is beneficial to improve the sensing link budget and accuracy of sensing measurements. A channel aggregation scheme, known as frequency stitching, allows multiple carrier frequencies to be combined, allowing sensing measurements to be performed over a much wider channel bandwidth compared to an SDEV's default operating channel bandwidth. Frequency stitching may be performed with overlapping channel frequencies or non-overlapping channel frequencies, the carrier frequency grid (CFG) configuration parameter determining the percentage of overlap. Carrier frequency grids of 0, 1, 2, and 3 represent no overlap, 25% overlap, 50% overlap and 75% overlap respectively. As for the frequency stitching type, which refers to the method used for the transmission of the channel sounding PPDU (sensing PPDU), it may be one of: intra-packet frequency stitching: different segments of the same sensing PPDU are transmitted on different channels; inter-packet frequency stitching: multiple sensing PPDUs are transmitted on different channels, and different segments of the same sensing PPDU are transmitted on the same channel; combined intra-packet frequency stitching and inter-packet frequency stitching: combination of the above two transmission methods.

Some other terminologies related to frequency stitching are: base channel, refers to a starting channel for performing UWB sensing when frequency stitching is enabled, and the starting channel refers to a channel on which fields such as a synchronization (SYNC) field and a start of frame delimiter (SFD) field are first transmitted; the number of transmissions, which is the total number of transmissions to be done at the different channel center frequencies for one measurement instance. In other words, number of transmissions refers to the number of carrier frequencies used for the frequency stitching.

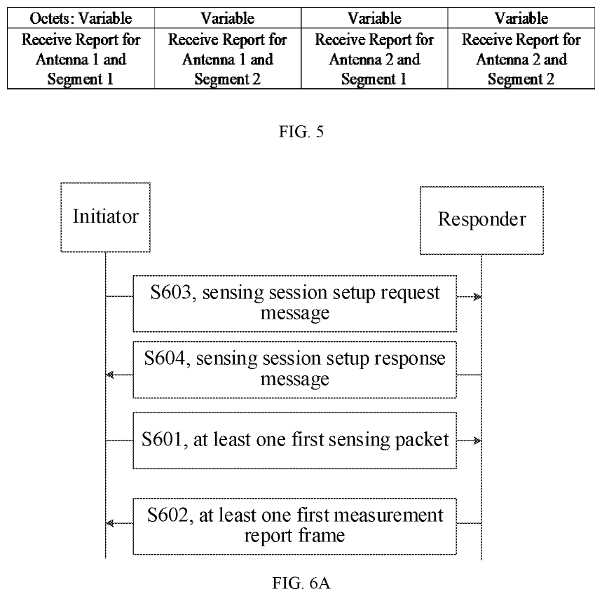

It is proposed that the CIR taps corresponding to a sensing measurement are carried in a CIR report IE, and the CIR report IE carried in the measurement report frame. The CIR taps are measured for each receive antenna of the responder and segment transmitted by the initiator pair and placed in receive report(s) field of the CIR report IE in a fixed order, e.g., in the sequence of antenna ID first and the segment index second. For example, when there are two Rx antennas and two segments, the receive report(s) field is formatted as shown in FIG. 5.

The above CIR report format may work well when all the CIR taps corresponding to a single sensing measurement are carried in the same CIR report IE, but it is possible that the CIR taps are split across multiple CIR report IEs and multiple frames, so the initiator may have difficulty assembling the CIR taps in the correct order. Similarly, in the multi-static case (i.e., when multiple responders are involved in a single sensing session) or in the sensing by proxy (SBP) case, it is not easy to identify which responder generated the CIR reports.

Solutions are proposed to introduce a unified sensing measurement report format to allow: easy identification of partial reports, and easy identification and aggregation of reports in the multi-static or SBP case. Here a partial report (or a CIR partial report) in the embodiments of the present disclosure refers to a report carrying all the CIR taps corresponding to a receive antenna and segment pair or corresponding to a receive antenna and segment pair on a particular channel. The partial report is generally carried in the receive report(s) field of a CIR Report IE.

The solution proposed by the present disclosure can be applied in any UWB sensing application that uses (sensing) measurement report frames. Besides, the solution of the present disclosure may be implemented in tags, smartphones, laptops, key fobs, vehicle, door locks etc. That is, the initiator and the responder can be devices such as tags, smartphones, laptops, key fobs, vehicle, door locks etc.

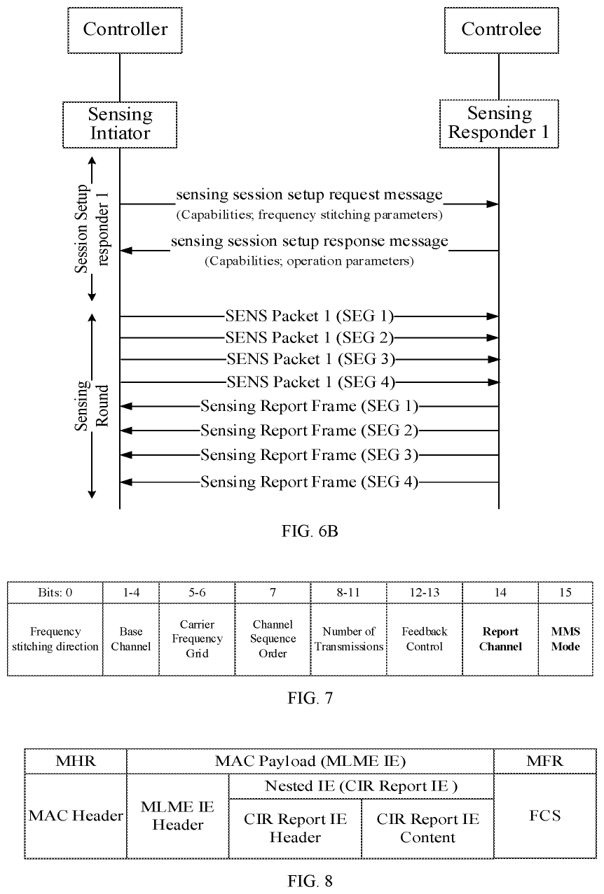

The embodiments of the present disclosure will be elaborated with reference to accompanying figures. The present disclosure provides a communication method involving the interaction between an initiator and a responder, applied for ultra-wideband sensing. Reference may be made to FIG. 6A, the communication method may include the following steps.
S601, an initiator transmits at least one first sensing packet to the responder, and the responder receives the at least one first sensing packet from the initiator.

Specifically, the at least one first sensing packet may be any packet that could be interchanged between an initiator and a responder for achieving the measurement of conditions of channels, in a possible implementation of the present disclosure, the first sensing packet could be a sensing PPDU (e.g., an HRP-SDEV PPDU) which is transmitted from the initiator to the responder through one or more channels. It should be noted that the number of first sensing packets may be one or multiple, which is not limited in the embodiments of the present disclosure. The number of first sensing packets can be determined based on actual needs, for example, when it is required to measure multiple channels, then it is possible to achieve such requirement with one first sensing packet including multiple segments or with multiple first sensing packets (each first sensing packet may include one or more segments).

Each of the at least one first sensing packet may include one or more segments. Relevant techniques in existing art would be adopted for the segmentation of the first sensing packet, the number of segments of a first sensing packet and the manner in which the first sensing packet is segmented are not limited in the embodiments of the present disclosure. For example, a segment may be a SENS field of an HRP-SDEV PPDU.

In a possible implementation of the present disclosure, the at least one first sensing packet includes one first sensing packet and the one first sensing packet includes a first preset number of segments; the at least one first measurement report frame includes multiple measurement report frames, and a number of the multiple measurement report frames is equal to the first preset number; or, the at least one first measurement report frame includes one measurement report frame. For the case where there is one first sensing packet with multiple segments, the generated at least one measurement report frame may be one or multiple.

In a possible implementation of the present disclosure, the first preset number of segments are transmitted on different channels.

In a possible implementation of the present disclosure, the at least one first sensing packet includes multiple sensing packets, and the multiple sensing packets are transmitted on different channels, each of the multiple sensing packets includes one or more segments; segments of the same sensing packet are transmitted on a same channel, or, segments of the same sensing packet are transmitted on different channels.

In a possible implementation of the present disclosure, the at least one first measurement report frame includes multiple measurement report frames, and the number of the multiple sensing packets is the same as the number of the multiple measurement report frames.

In a possible implementation of the present disclosure, in a case where the segments of the same sensing packet are transmitted on the same channel, the at least one first measurement report frame includes one measurement report frame, and the one measurement report frame is indicative of the first reporting set corresponding to the respective partial report, wherein measurements for each segment are reported for aggregation of the different channels on which the multiple sensing packets are transmitted.
S602, the responder transmits at least one first measurement report frame according to the at least one first sensing packet to the initiator, and the initiator receives the at least one first measurement report frame from the responder.

Further, the at least one first measurement report frame is used to provide a result of first measurement performed by the responder on the at least one first sensing packet, and a respective first measurement report frame of the at least one first measurement report frame is indicative of an identification of the respective first measurement report frame and the first measurement to which the at least one first sensing packet belongs.

Upon receiving the at least one first sensing packet from the initiator, the responder may perform measurement of the at least one first sensing packet so as to obtain the at least one first measurement report frame.

Here the first measurement refers to one measurement instance mentioned above, and may include the transmission and measurement of one or more sensing packets. Detailed description will be made later with reference to specific examples. The result of the first measurement refers to all the measurement results of the first measurement, that is, results obtained by measuring all of the at least one first sensing packet, e.g., all the receive reports (carried in the receive report(s) field of a CIR report IE) of one measurement instance.

It should be noted that although the measurement is carried out for each of the at least one first sensing packet, but the at least one first measurement report frame for carrying the result of the first measurement may be implemented in different ways. In a possible implementation of the present disclosure, the number of the at least one first measurement report frame may be as same as the number of the at least one first sensing packet, that is, each packet has its corresponding first measurement report frame. In another possible implementation of the present disclosure, results obtained by measuring all of the at least one first sensing packet may be carried in one first measurement report frame. In another possible implementation of the present disclosure, each segment of each packet may have its corresponding first measurement report frame. There is no limitation on the number of the at least one first measurement report frame, as long as all of the at least one first measurement report frame could provide results obtained by measuring all of the at least one first sensing packet to the initiator.

In order to enable the initiator to correctly distinguish each first measurement report frame, the respective first measurement report frame is indicative of an identification of the respective first measurement report frame and the first measurement to which the at least one first sensing packet belongs. In this way, when there are different measurement instances implemented by the initiator and the responder, and when the result of one measurement instance (the first measurement) is carried in different measurement report frames, the initiator could determine to which measurement instance each first measurement report frame belongs, as well as distinguish first measurement report frames belonging to the same measurement instance. In a possible implementation of the present disclosure, the respective first measurement report frame includes a report number for indicating the identification of the first measurement report frame and a measurement number for identifying the first measurement to which the at least one first sensing packet belongs.

In a possible implementation of the present disclosure, the at least one first sensing packet includes one or more segments, and the respective first measurement report frame includes at least one partial report, where a respective partial report of the at least one partial report corresponds to a first reporting set of a segment of the at least one first sensing packet and an antenna of the responder for receiving the segment. Here the first reporting set could also be referred to as a combination or a pair or a group of a segment of the at least one first sensing packet and an antenna of the responder for receiving the segment. That is, each partial report carries all the CIR taps corresponding to a receive antenna and segment pair. For example, when the at least one first sensing packet includes one first sensing packet, and this first sensing packet includes two segments (SEG1 and SEG2), and the responder has two receive antennas (ANT1 and ANT2), then there would be four partial reports (PR1, PR2, PR3 and PR4), each partial report corresponds to a segment and antenna pair, where PR1 corresponds to the set of SEG1 and ANT1, PR2 corresponds to the set of SEG2 and ANT1, PR3 corresponds to the set of SEG1 and ANT2, PR4 corresponds to the set of SEG2 and ANT2. It should be noted that here only one first sensing packet is taken as an example to illustrate the detailed implementations, but the principle also applies for the case of multiple first sensing packets.

In a possible implementation of the present disclosure, the respective partial report is indicative of the first reporting set corresponding to the respective partial report. In a possible implementation of the present disclosure, the respective partial report includes a segment identifier for identifying the segment in the first reporting set corresponding to the respective partial report and an antenna identifier for identifying the receive antenna (or the corresponding receive (Rx) chain) in the first reporting set corresponding to the respective partial report. The segment identifier and the antenna identifier may be implemented respectively as the segment ID field and the Rx antenna ID field in the following examples.

In a possible implementation of the present disclosure, the respective first measurement report frame further includes a first report field for indicating whether the segment identifier and the antenna identifier are present. The first report field may be implemented as the report IDs presence field in the following examples.

In a possible implementation of the present disclosure, the channel identifier is a relative index of the first channel on which the segment is transmitted by the initiator.

In a possible implementation of the present disclosure, the respective first measurement report frame includes a segment bitmap for identifying the segment in the first reporting set corresponding to the respective partial report and an antenna bitmap for identifying the antenna in the first reporting set corresponding to the respective partial report. The segment bitmap and the antenna bitmap may be implemented respectively as the segment ID bitmap field and the Rx antenna ID bitmap field in the following examples.

In a possible implementation of the present disclosure, the respective first measurement report frame further includes a second report field for indicating whether the segment bitmap, the antenna bitmap and the channel bitmap are present. The second report field may be implemented as the partial report bitmap length field in the following examples.

In a possible implementation of the present disclosure, the respective partial report corresponds to a second reporting set of a segment of the at least one first sensing packet, an antenna of the responder for receiving the segment and a first channel on which the segment is transmitted by the initiator. Here the second reporting set could also be referred to as a combination or a pair or a group of a segment of the at least one first sensing packet, an antenna (or the corresponding Rx chain) of the responder for receiving the segment and a first channel on which the segment is transmitted by the initiator. That is, each partial report carries all the CIR taps corresponding to a receive antenna and segment pair on a particular channel. For example, when the at least one first sensing packet includes one first sensing packet, this first sensing packet includes two segments (SEG1 and SEG2) and is transmitted on one channel (CH1), and the responder has two receive antennas (ANT1 and ANT2), then there would be four partial reports (PR1′, PR2′, PR3′ and PR4′), each partial report corresponds to a segment and antenna pair, where PR1′ corresponds to the set of SEG1, ANT1 and CH1, PR2 corresponds to the set of SEG2, ANT1 and CH1, PR3 corresponds to the set of SEG1, ANT2 and CH1, PR4 corresponds to the set of SEG2, ANT2 and CH1.

In a possible implementation of the present disclosure, the respective partial report is indicative of the second reporting set corresponding to the respective partial report. In a possible implementation of the present disclosure, the respective partial report includes a segment identifier for identifying the segment in the second reporting set corresponding to the respective partial report, an antenna identifier for identifying the antenna (or the corresponding Rx chain) in the second reporting set corresponding to the respective partial report and a channel identifier for identifying the first channel in the second reporting set corresponding to the respective partial report. The segment identifier, the antenna identifier and the channel identifier may be implemented respectively as the segment ID field, the Rx antenna ID field, and the channel ID field in the following examples.

In a possible implementation of the present disclosure, the respective first measurement report frame further includes a first report field for indicating whether the segment identifier, the antenna identifier and the channel identifier are present. The first report field may be implemented as the report IDs presence field in the following examples.

In a possible implementation of the present disclosure, the channel identifier is a relative index of the first channel on which the segment is transmitted by the initiator.

In a possible implementation of the present disclosure, the respective first measurement report frame includes a segment bitmap for identifying the segment in the second reporting set corresponding to the respective partial report, an antenna bitmap for identifying the antenna (or the corresponding Rx chain) in the second reporting set corresponding to the respective partial report and a channel bitmap for identifying the channel in the second reporting set corresponding to the respective partial report. The segment bitmap, the antenna bitmap and the channel bitmap may be implemented respectively as the segment ID bitmap field, the Rx antenna ID bitmap field, and the channel ID bitmap field in the following examples.

In a possible implementation of the present disclosure, the respective first measurement report frame further includes a second report field for indicating whether the segment bitmap, the antenna bitmap and the channel bitmap are present. The second report field may be implemented as the partial report bitmap length field in the following examples.

In a possible implementation of the present disclosure, a first measurement report frame of the at least one first measurement report frame is indicative of a first parameter for all partial reports carried in the at least one first measurement report frame, and indications for the first parameter are omitted in remaining measurement report frames other than the first measurement report frame. Here the first parameter may refer to parameters carried in the report parameter control field as described above. The measurement report may include multiple partial reports, and the first parameter may be parameters common to all partial reports carried in the at least one first measurement report frame, that is, the at least one first measurement report frame used for carrying all the partial reports share the first parameter, so it is possible to simply carry the first parameter in the first measurement report frame of the at least one first measurement report frame, and omit indications for the first parameter in other measurement report frames, so as to reduce the signaling overhead.

In a possible implementation of the present disclosure, the respective first measurement report frame is further indicative of an address of the responder. In a possible implementation of the present disclosure, the respective first measurement report frame comprises an address identifier for identifying the address of the responder. In a possible implementation of the present disclosure, the respective first measurement report frame further includes a sixth report field for indicating whether the address identifier is present. The address identifier may be carried in the Responder Address field in the following example.

In the communication method according to the present disclosure, the CIR report (CIR taps) corresponding to a single sensing measurement may be divided into two or more partial CIR reports, each partial CIR report carrying all the CIR taps corresponding to a receive antenna and segment pair on a particular channel; so that the partial report allows the CIR report to be divided into smaller components, each component carrying a complete set of CIR taps for a receive antenna and segment pair. Even if some components are not received, the remaining received components can still be parsed, allowing partial sensing measurements to be obtained.

In addition, in the communication method, the CIR report carries a unique identifier for the report (report number mentioned above) and indices to identify the partial report(s) (measurement number mentioned above), so that partial report corresponding a specific receive antenna and segment pair on a particular channel can be accurately identified.

According to the communication method provided by the embodiments of the present disclosure, at least one first sensing packet is transmitted from an initiator to a responder, and the responder then transmits at least one first measurement report frame according to the at least one first sensing packet, where the at least one first measurement report frame is used to provide a result of first measurement performed by the responder on the at least one first sensing packet, and a respective first measurement report frame of the at least one first measurement report frame is indicative of an identification of the respective first measurement report frame and the first measurement to which the at least one first sensing packet belongs. In this way, the initiator is enabled to identify measurement report frames from the responder, and could thus arrange these measurement report frames in a right order, thus improving the accuracy of the measurement.

In a possible implementation of the present disclosure, before the initiator transmits the at least one first sensing packet to the responder in S601, the method further includes following step.
S603, the initiator transmits a sensing session setup request message to the responder, and the responder receives the sensing session setup request message.

Further, the sensing session setup request message is indicative of a second channel for transmitting the at least one first measurement report frame.

An exemplary process is also shown in FIG. 6B, which is a process of one sensing measurement instance between the initiator and the responder. As shown in FIG. 6B, during the session setup phase, an SDEV can be regarded as a controller and assumes itself as an initiator, and determines another SDEV (controlee shown in FIG. 6B) as a responder, that is, the controller assumes the role of the initiator and assigns the role of the responder to the controlee. The initiator first transmits a sensing session setup request message to the responder to initiate a sensing session with the responder, where the sensing session setup request message includes the initiator's sensing capabilities, an AC IE carrying parameters related to sensing as well as frequency stitching. The responder responds with a sensing session setup response message carrying its sensing capabilities as well as operating parameters. This session setup phase is actually a handshake between the controller and the controlee, so that both parties could know capabilities of the other party so as to implement subsequent sensing. Subsequently in a sensing round (one time of sensing packet transmission and measuring), the initiator transmits a sensing packet with four segments, each segment transmitted on one of the four different carrier frequencies as specified by the frequency stitching CFG parameter (which may be notified as one of frequency stitching parameters by the initiator). Upon receiving the sensing packet, the responder measures the CIR taps for each of the bit set to 1 in the CIR Bitmap field of the AC IE. A partial CIR report is generated for each of the pair made up of the responder's receive antenna and segment of the sensing packet for each of the frequency stitched channel. In this example, the feedback control field of the AC IE would be set to a value of 1 indicating report for all transmissions after the last transmission, and four sensing measurement report frames are transmitted, each frame carrying the partial CIR reports corresponding to one segment (or one channel). The responder then transmits four measurement report frames respectively corresponding to the four segments. Here it should be noted that the number of segments shown in the figure is simply exemplary, and there could be more or less segments in actual applications.

In a possible implementation of the present disclosure, the sensing session setup request message may include sensing capabilities of the initiator, an AC IE carrying parameters related to sensing as well as frequency stitching. FIG. 7 illustrates the structure of the Frequency Stitching Parameters subfield of the Sensing Control field of the AC IE field. As shown in FIG. 7, and the interesting fields in the Frequency Stitching Parameters subfield of the Sensing Control field of the AC IE field are as follows.
CFG: used for indicating a CFG configuration parameter, such CFG configuration parameter indicates whether the carrier frequencies of the channels overlap; for example, the CFG parameter of 0, 1, 2, and 3 represent no overlap, 25% overlap, 50% overlap and 75% overlap respectively.
Number of transmissions: used for indicating the total number of transmissions to be done at the different channel center frequencies; in other words, the number of transmissions refers to the number of carrier frequencies used for the frequency stitching.
Channel sequence order: used for indicating whether the segments are transmitted in a sequential manner or an out-of-sequence manner, for example, when the channel sequence order field is 0, it indicates the sequential manner, and when the channel sequence order field is 1, it indicates the out-of-sequence manner. The sequential manner may refer to a manner in which adjacent segments of the same sensing packet are sequentially transmitted on channels whose carrier frequencies follow certain rules, or whose carrier frequencies distribute regularly, and the out-of-sequence manner may refer to a manner in which overlapped segments of the same sensing packet or overlapped sensing packets may be separated in the another dimension (different from the dimension where the overlapping occurs). For example, the overlapping may occur in the frequency domain, that is, channels which carry two adjacent segments may overlap, then these two segments may be separated in the time domain, for example, the time interval between the transmission of these two segments may be greater than 1 ms.

Frequency stitching type (not shown in the figure): used for indicating that the frequency stitching type mentioned above with different values, for example, when its value is 0, the frequency stitching type is the intra-packet frequency stitching, when its value is 1, the frequency stitching type is the inter-packet frequency stitching, when its value is 2, the frequency stitching type is combination of intra-packet and inter-packet frequency stitching.

Report channel field: used for indicating the channel for transmitting the measurement report frame. For example, the base channel is used for transmitting the measurement report frame when its value is 0, and the channel used to transmit the last sensing packet (or its last segment) is used for transmitting the measurement report frame when its value is 1. Here the base channel as mentioned above, refers to a starting channel for performing UWB sensing when frequency stitching is enabled, and the last channel refers to a channel on which the last segment of the last sensing packet is transmitted. So it is possible that the base channel or the last channel could be used as the above second channel, depending on specific configurations.

MMS mode: used for indicating a gap between any two overlapping transmissions of the sensing packets or the segments of the same packet. For example, the gap may be less than 1 ms when the value of the MMS mode field is 0 (corresponding to the sequential manner); and the gap between any two overlapping transmissions of the sensing packets or the segments of the same packet may be at least 1 ms when the value of the MMS mode field is 1 (corresponding to the out-of-sequence manner). With reference to the above description of the channel sequence order field, there could be two kinds of transmission, the sequential manner or the out-of-sequence manner, so this could also be indicated by the MMS mode.

Feedback control: used for indicating different report formats. For example, when its value is 1, the report is for all transmissions after the last transmission, when its value is 2, the report is for aggregated channel after the last transmission.

CIR bitmap: used for instructing the responder to measure the CIR taps for each of the bit set to 1 in the CIR bitmap field.

It should be noted that values such as 0, 1, and 2 used for describing the above fields are just exemplary, other values may also be set for realizing the functions defined for these fields, the specific values are not limited in the embodiments of the present disclosure.

Besides, throughout the document, specific descriptions, for example, those for describing the fields of different structures (AC IE, CIR report IE, processed target feature IE, etc.) may be made using the term “measurement report frame”, and may be applicable for both first measurement report frame and second measurement report frame.
S604, the responder transmits a sensing session setup response message and the initiator receives the sensing session setup response message from the responder.

Further, where the sensing session setup response message is determined by the responder according to the sensing session setup request message.

In a possible implementation of the present disclosure, the sensing session setup response message may include sensing capabilities of the responder as well as operating parameters.

As mentioned above, there may be two kinds of reports, formats (or structures) of these two reports will be elaborated in detail as follows. For the first kind of report, i.e., the windows-based CIR report, there may be two formats for the CIR report IE, and for the second kind of report, i.e., the processed target features report, an exemplary processed target feature IE is proposed.

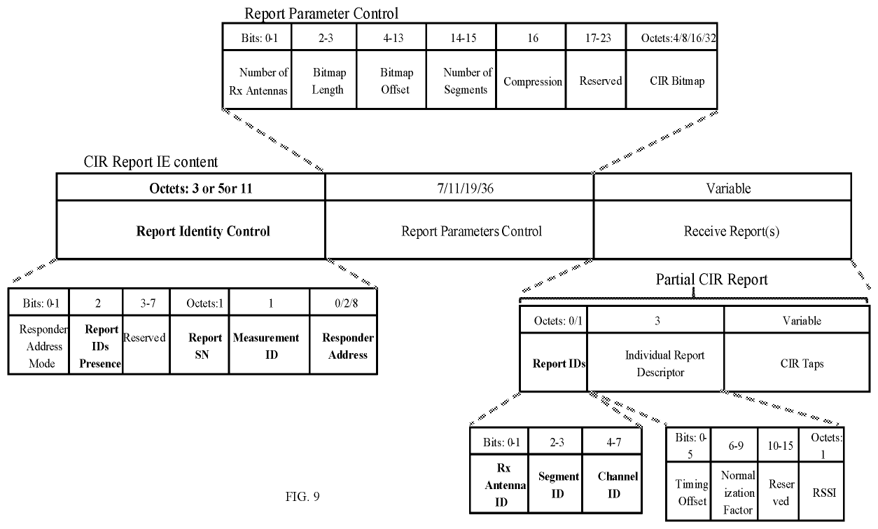

The structure of the measurement report frame will be described in the first place. The measurement report frame is transmitted on a media access control (MAC) sub-layer. As shown in FIG. 8, the MAC sub-layer consists of a MAC header, a MAC payload and a MAC Footer (MFR), and the MAC layer management entity information element (MLME IE) payload consists of an MLME IE header field, a nested IE (i.e., CIR report IE) field consisting of a CIR report IE header field and a CIR report IE content field, and the CIR report IE content field corresponds to the measurement report frame.

A specific example format of the CIR report IE content field corresponding to the measurement report frame will be described with FIG. 9, the interesting fields are as follows:
(1) Report identity control: carries information that can be used to identify a measurement report frame. This field serves to provide parameters that would be used by the initiator to identify a certain measurement report frame, so the following fields may be included.

Responder address mode: indicates the presence and size of the responder address field, for example:
b00: indicates that Responder Address field is not present;
b01: reserved;
b10: Responder Address field contains a short address (16 bit);
b11: Responder Address field contains an extended address (64 bit).

Report ID presence: indicates if the Report ID field is present in the measurement report frame.

Report sequence number (SN): refers to a unique sequence number that identifies a specific measurement report frame. The report SN can be used for selective re-transmissions in case of transmission failure. The report SN is locally generated by the responder. This field may be the report number for indicating the identification of the first measurement report frame as described above.

Measurement ID (MID): refers to a unique ID that identifies a particular sensing measurement instance (the first measurement as described above). The MID can be used by the initiator to identify the report including the at least one measurement report frame corresponding to a particular measurement. The MID is locally generated by the responder. This field may be the measurement number for identifying the first measurement to which the at least one first sensing packet belongs as described above.

Responder address: identifies the SDEV (the responder) that generated the measurement report frame. It may be present in the SBP case and is optional for non-SBP. It may be either the 2 octets short address assigned to the responder or the 8 octets extended address of the responder. If the 2 octets short address is used in the CIR report transmitted by the responder, the initiator may replace it with the 8 octets extended address of the responder when forwarding the report to the sensing requesting device if the sensing requesting device is not part of the same network as the sensing responder. Further, if the CIR report carries the address of the responder that generated the report would make it possible for the device which receives the report to uniquely identify the report.
(2) Report parameter control: carries the parameters common to all partial reports with the same MID such as number of Rx antennas, Number of Segments, CIR bitmap etc. It should be noted that, in the case where there are multiple measurement report frames, the report parameter control field could appear simply in the first measurement report frame among the multiple measurement report frames, and could be omitted in other measurement report frames. The presence/absence of the report parameter control field may be indicated by an RPC presence field in the RIC, which is set to 1 in the first measurement report frame.
(3) Receive report(s): carries one or more partial CIR reports (hereafter referred to as partial reports).

Report IDs: identifies a partial report and is present when the Receive reports of the same measurement are carried in different measurement report frame frames. If the Report ID field is not present, it means that the entire report (all the partial reports) is carried in the IE. The Report IDs may include the following fields:
Rx antenna ID: ID of the receive antenna (or the corresponding receive (Rx) chain) corresponding to the partial report carrying the CIR taps;
Segment ID: ID of the segment of the sensing packet corresponding to the partial report carrying the CIR taps;
Channel ID: for a frequency stitched packet, it indicates the channel in which the CIR taps are measured. The Channel ID may be a relative index (instead of the actual physical channel index), e.g., CH 0 being the base channel, CH 1 being the next channel that is closest to the base channel etc. The field is reserved for a normal sensing packet. If more bits are available (e.g., 7 bits, the channel ID may also represent the actual logical ID of the channel used). As described above, a partial report may correspond to a first reporting set or a second reporting set, so for a partial report corresponds to the first reporting set, the Report IDs may simply include the Rx antenna ID and the Segment ID, for a partial report corresponds to the second reporting set, the Report IDs may simply include all of the above three IDs.

Individual report descriptor: carries report parameters specific to the partial report such as Timing offset between the reference tap and the CIR report timing grid, the normalization factor applied to the CIR Taps being reported in the CIR Taps field, the received signal strength at the antenna for the received sequence used to generate this Receive Report field.

CIR Taps: contains the CIR tap values, one value for each bit in the CIR Bitmap that is set to one, each CIR tap consists of a signed in-phase (I) value and a signed quadrature (Q) value.

It should be noted that the specific values, and lengths, names of the above fields are just for illustration purpose, other values could be taken, as long as the function of each field is realized. Although not shown in FIG. 9, the report frame may also include a Session ID field (e.g., in the report identity control field) to identify the sensing session corresponding to the measurement.

As described above, the first measurement report frame may include a report number for indicating the identification of the first measurement report frame and a measurement number for identifying the first measurement to which the at least one first sensing packet belongs, with reference to the exemplary format shown in FIG. 9, the report number may be the Report SN and the measurement number may be the Measurement ID.

In a possible implementation, the respective partial report includes a segment identifier for identifying the segment in the second reporting set corresponding to the respective partial report, an antenna identifier for identifying the antenna in the second reporting set corresponding to the respective partial report and a channel identifier for identifying the first channel in the second reporting set corresponding to the respective partial report. Further, the segment identifier, the antenna identifier and the channel identifier may be the Rx antenna ID, the segment ID and the channel ID in the report IDs field respectively shown in FIG. 9.

In a possible implementation, the respective first measurement report frame further includes a first report field for indicating whether the segment identifier, the antenna identifier and the channel identifier are present, Specifically, the first report field may be the report IDs presence field shown in FIG. 9.

The correspondence between the report IDs field and the segment identifier, the antenna identifier and the channel identifier, the correspondence between the report IDs presence field and the first report field, the correspondence between the report SN field and the report number, the correspondence between the measurement ID field and the measurement number are the same in specific examples, which will not be repeated again for brevity.

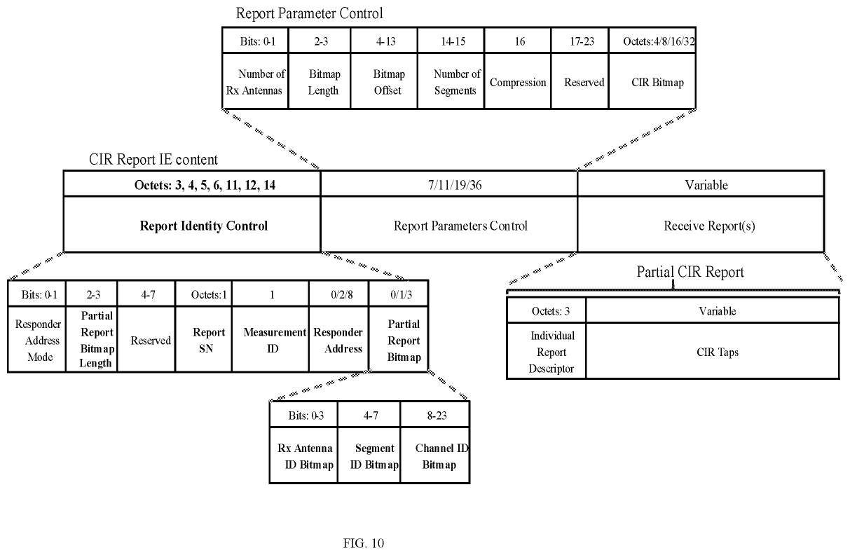

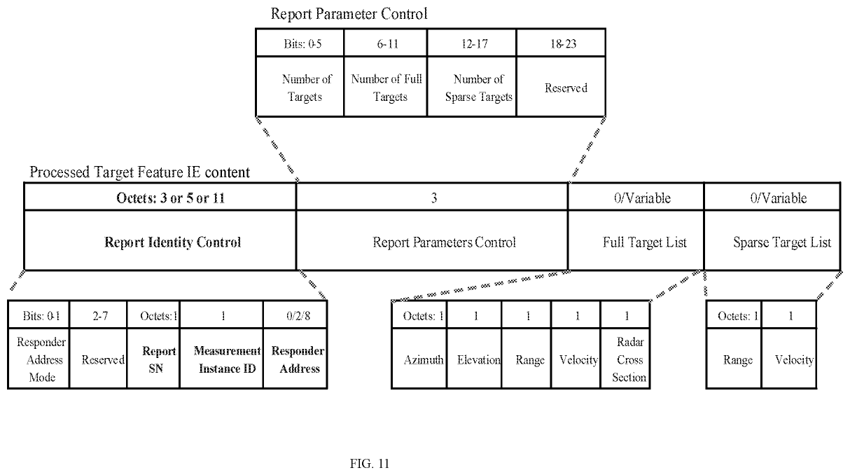

In FIG. 9, the partial report carried in the receive report field is identified using the report IDs field in the receive report field, FIG. 10 shows another example format of the CIR report IE content field corresponding to the measurement report frame, in this format, bitmaps are used to indicate the receive antenna ID(s), segment ID(s) and channel ID(s) corresponding to the partial CIR report(s) carried in the Receive Report field. The interesting fields are as follows.
(1) Report Identity Control: carries information that can be used to identify a measurement report frame. This section serves to provide parameters that would be used by the initiator to identify a certain measurement report frame, so the following fields may be included.

Responder address mode: indicates the presence and size of the responder address field, where:
b00: indicates that responder address field is not present;
b01: reserved;
b10: Responder address field contains a short address (16 bit);
b11: Responder address field contains an extended address (64 bit).

Partial report bitmap length: identifies the length of the partial report bitmap field, valid values:
b00: 0 bits, i.e., partial report bitmap field is absent.
b 01: 8 bits (only the Rx antenna ID bitmap and segment ID bitmap are present)
b 10: 24 bits (all 3 bitmaps are present);
b11: reserved.

Report SN: refers to a unique sequence number that identifies a specific measurement report frame. The Report SN can be used for selective re-transmissions in case of transmission failure. The Report SN is locally generated by the responder. This field may be the report number for indicating the identification of the first measurement report frame as described above.

MID: refers to a unique ID that identifies a particular measurement (the first measurement as described above). The MID can be used by the initiator to identify reports including the at least one measurement report frame corresponding to a particular measurement. The MID is locally generated by the responder. This field may be the measurement number for identifying the first measurement to which the at least one first sensing packet belongs as described above.

Responder address: identifies the SDEV (the responder) that generated the measurement report frame. It may be present in the SBP case and is optional for non-SBP. It may be either the 2 octets short address assigned to the responder or the 8 octets extended address of the responder. If the 2 octets short address is used in the CIR report transmitted by the responder, the initiator may replace it with the 8 octets extended address of the responder when forwarding the CIR Report to the sensing requesting device.

Partial report bitmap (present when the receive reports of the same measurement are carried in different measurement report frames). If the bitmap is not present, the entire report (all the partial reports) is carried in the IE. The Report IDs may include the following fields:
Rx antenna ID Bitmap: identifies that the ID of the receive antenna corresponding to the partial report carrying the CIR taps is present.
Segment ID bitmap: identifies that the ID of the segment of the sensing packet corresponding to the partial report carrying the CIR taps is present.
Channel ID bitmap: for a frequency stitched packet, it indicates the channel in which the CIR taps are measured. This filed may be reserved for a normal sensing packet. As described above, a partial report may correspond to a first reporting set or a second reporting set, so for a partial report corresponds to the first reporting set, bits in the Rx antenna ID bitmap and the Segment ID bitmap corresponding to this partial report may be set to, e.g., 1, for a partial report corresponds to the second reporting set, bits in the Rx antenna ID bitmap, the Segment ID bitmap and the channel ID bitmap corresponding to this partial report may be set to, e.g., 1, so that the initiator may identify the partial report from the measurement report frame.
(2) Report Parameter Control: carries the report parameters common to all partial reports with the same MID such as Number of Rx Antennas, Number of Segments, CIR Bitmap etc. It should be noted that, in the case where there are multiple measurement report frames, the Report Parameter Control field could appear simply in the first measurement report frame among the multiple measurement report frames, and could be omitted in other measurement report frames. It should be noted that, in the case where there are multiple measurement report frames, the Report Parameter Control field could appear simply in the first measurement report frame among the multiple measurement report frames, and could be omitted in other measurement report frames. The presence/absence of the Report Parameter Control field may be indicated by a RPC Presence field in the RIC, which is set to 1 in the first measurement report frame.
(3) Receive Report(s): carries one or more partial reports.

Individual Report Descriptor: carries report parameters specific to the partial report such as Timing offset between the reference tap and the CIR report timing grid, the normalization factor applied to the CIR Taps being reported in the CIR Taps field, the received signal strength at the antenna for the received sequence used to 6 generate this Receive Report field.

CIR Taps: contains the CIR tap values, one value for each bit in the CIR Bitmap that is set to one, each CIR tap consists of a signed in-phase (I) value and a signed quadrature (Q) value.

It should be noted that the specific values, and lengths, names of the above fields are just for illustration purpose, other values could be taken, as long as the function of each field is realized. Although not shown in FIG. 10, the report frame may also include a Session ID field (e.g., in the Report Identity Control field) to identify the sensing session corresponding to the measurement.

As described above, the respective first measurement report frame may include a segment bitmap for identifying the segment in the second reporting set corresponding to the respective partial report, an antenna bitmap for identifying the antenna in the second reporting set corresponding to the respective partial report and a channel bitmap for identifying the channel in the second reporting set corresponding to the respective partial report, with reference to the exemplary format shown in FIG. 10, the segment bitmap, the antenna bitmap and the channel bitmap may be the Rx Antenna ID bitmap, the Segment ID bitmap and the Channel ID bitmap in the Partial Report Bitmap field respectively shown in FIG. 10.

In the communication method according to a possible implementation of the present disclosure, the respective first measurement report frame further includes a second report field for indicating whether the segment bitmap, the antenna bitmap and the channel bitmap are present. Specifically, the second report field may be the partial report bitmap length field shown in FIG. 10. When the Partial Report Bitmap Length field is 00, it indicates that the length of the Partial Report Bitmap field is 0 bit, i.e., Partial Report Bitmap field is absent; when the Partial Report Bitmap Length field is 01, it indicates that the length of the Partial Report Bitmap field is 8 bits, i.e., only the Rx Antenna ID Bitmap and Segment ID Bitmap in the Partial Report Bitmap field are present; when the Partial Report Bitmap Length field is 10, it indicates that the length of the Partial Report Bitmap field is 24 bits, i.e., the Rx Antenna ID Bitmap, Segment ID Bitmap and the Channel ID bitmap in the Partial Report Bitmap field all are present; and when the Partial Report Bitmap Length field is 11, it indicates that the field is reserved.

In the communication method according to a possible implementation of the present disclosure, the at least one partial report includes multiple partial reports, and the multiple partial reports are arranged in a preset order, e.g., in the sequence of the receive antenna ID first, the segment ID second in the non-frequency stitching, or in the sequence of the segment ID first, the receive antenna ID second in the non-frequency stitching; or in the sequence of the receive antenna ID first, the segment ID second, and the channel ID third in the frequency stitching, and the like. Such fixed order arrangement applies for both frequency stitching case and non-frequency stitching.

In a possible implementation, instead of the reporting the raw CIR taps, it is also possible that a responder may first process the measured CIR taps and only report the processed target features such as AoA, range, velocity, RCS etc. A possible format of the Processed Target Feature IE used to report the processed target features is illustrated in FIG. 11. The interesting fields of the Processed Target Feature IE content fields are as follows:
(1) Report Identity Control: Carries information that can be used to identify a measurement report frame. This section serves to provide parameters that would be used by the initiator to identify a certain measurement report frame, so the following fields may be included:

Responder Address Mode: Indicates the presence and size of the Responder Address field, for example:
b00: Responder Address field is not present.
b01: reserved
b10: Responder Address field contains a short address (16 bit).
b11: Responder Address field contains an extended address (64 bit)

Report SN: refers to a unique sequence number that identifies a specific measurement report frame. The Report SN can be used for selective re-transmissions in case of transmission failure. The Report SN is locally generated by the responder. This field may be the report number for indicating the identification of the first measurement report frame as described above.

MID: refers to a unique ID that identifies a particular measurement (the first measurement as described above). The MID can be used by the initiator to identify reports corresponding to a particular measurement. The MID is locally generated by the responder. When both CIR Report and process target features are reported for the same measurement, the same MID may be used in both the CIR Report IE and the Processed Target Feature IE in order to aid the initiator to map the two IEs. This field may be the measurement number for identifying the first measurement to which the at least one first sensing packet belongs as described above.

Responder Address: Identifies the SDEV (the responder) that generated the processed target feature (the measurement report frame). It may be present in the SBP case and is optional for non-SBP. It may be either the 2 octets short address assigned to the responder or the 8 octets extended address of the responder. If the 2 octets short address is used in the Processed Target Feature IE transmitted by a responder, the initiator may replace it with the 8 octets extended address of the responder when forwarding the Processed Target Feature IE to the sensing requesting device.
(2) Report Parameter Control: carries the report parameters common to all reports with the same MID such as Number of Targets, Number of Full Targets, Number of Sparse Targets etc. It should be noted that, in the case where there are multiple measurement report frames, the Report Parameter Control field could appear simply in the first measurement report frame among the multiple measurement report frames, and could be omitted in other measurement report frames. It should be noted that, in the case where there are multiple measurement report frames, the Report Parameter Control field could appear simply in the first measurement report frame among the multiple measurement report frames, and could be omitted in other measurement report frames. The presence/absence of the Report Parameter Control field may be indicated by a RPC Presence field in the RIC, which is set to 1 in the first measurement report frame.
(3) Full Target List: carries the complete processed features such as:
   Azimuth: Azimuth of the target
   Elevation: Elevation of the target
   Range: Range of the target
   Velocity: Velocity of the target
   RCS: Radar cross section of the target
(4) Sparse Target List: Carries the partial processed features such as:
   Range: Range of the target
   Velocity: Velocity of the target

It should be noted that the Report Identity Control field, the Report Parameter Control field, and the Receive Report(s) field in the CIR report IE as described above are just functional division of a measurement report frame, in actual applications, as long as functions of these fields are realized, these fields could be named in other ways, depending on actual needs. Although not shown in FIG. 11, the report frame may also include a Session ID field (e.g., in the Report Identity Control field) to identify the sensing session corresponding to the measurement.

As can be seen from the above description, the indication of the partial report is done in different ways by using the above Report IE formats, for the CIR Report IE case, it is possible to directly carry the Report IDs in each Receive Report (as shown in FIG. 9), or indicate the IDs by using bitmaps carried in the Report Identity Control field of a measurement report frame, for the processed target feature IE case, the solution would be similar as the later solution for the CIR Report IE.

Regarding the Report Parameter Control field, it is possible to further indicate reference tap timestamp for each receive antenna of the responder. Detailed description will be made for illustrating the indication of such reference tap timestamp. In the communication method according to a possible implementation of the present disclosure, the respective first measurement report frame is further indicative of a first reference tap timestamp for all of the at least one partial report.

In a possible implementation, the respective first measurement report frame includes a first reference tap timestamp field for indicating the first reference tap timestamp.

In a possible implementation, the respective first measurement report frame further includes a third report field for indicating whether the first reference tap timestamp field is present.

In a possible implementation, the respective partial report is indicative of an offset between the first reference tap timestamp and a second reference tap timestamp for the respective partial report.

In a possible implementation, the respective partial report includes an offset field for indicating the offset between the first reference tap timestamp and the second reference tap timestamp for the respective partial report.

In a possible implementation, the respective partial report further includes a fourth report field for indicating whether the offset field is present.

In a possible implementation, the respective partial report is indicative of a second reference tap timestamp for the respective partial report.

In a possible implementation, the respective partial report includes a second reference tap timestamp field for indicating the second reference tap timestamp for the respective partial report.

In a possible implementation, the respective partial report further includes a fifth report field for indicating whether the second reference tap timestamp field is present.

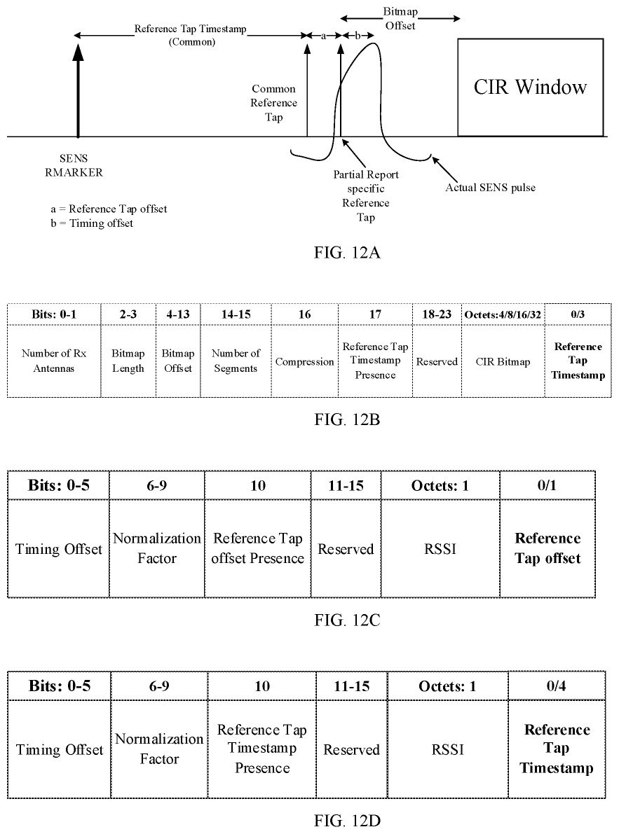

with reference to FIG. 12A to 12D, when the earliest CIR tap (above a certain threshold) is used as the reference tap for the CIR report, and there is a clear Line Of Sight (LOS) between the Initiator (transmitter) and the Responder (receiver), it may not be necessary to explicitly signal the timestamp of the reference tap. However, in many cases, it may be beneficial to explicitly signal the timestamp of the reference tap user for the CIR report, for example when either one or both of the initiator (transmitter) and the responder (receiver) is in motion, or when the strongest CIR tap is used as the reference tap. There may be two ways for signaling the reference tap in the CIR report. The first way is to choose one receive antenna from the multiple antennas of the responder as a common reference, and the offset with respect to the chosen common reference of each antenna could be carried in the Individual Report Descriptor field of each Receive Report field, or the second way is that an absolute reference tap would be directly reported in the Individual Report Descriptor field of each Receive Report field.

In the first manner, in order to reduce the signaling overhead, the reference tap of one partial report (i.e., a receive antenna—segment pair) may be chosen as a common reference tap (corresponding to the above first reference tap timestamp) as shown in FIG. 12A and signaled in the Reference Tap Timestamp field (corresponding to the above first reference tap timestamp field) in the Report Parameter Control field, as shown in FIG. 12B. A common point in time known to both initiator and the responder is used as the reference time for the Reference Tap Timestamp field. For example, the RMARKER of the sensing packet that is used to generate the CIR report may be used as the reference time for the Reference Tap Timestamp field. Or, the start time of the slot in which the sensing packet is transmitted may be used as the reference time. The reference time offset (corresponding to the above offset between the first reference tap timestamp and a second reference tap timestamp for the respective partial report), if any, between the reference tap (corresponding to the above second reference tap timestamp) for a partial report (i.e., a receive antenna—segment pair) and the common reference tap (corresponding to the above first reference tap timestamp) may be signaled in the Reference Tap Offset field (corresponding to the above offset field) in the Individual Report Descriptor field of each Receive Report field, as shown in FIG. 12C. The time unit for both fields is 2⁻⁷ of the 499.2 MHz chipping period, which is approximately 15.65 ps. An example using the RMARKER of the sensing packet as the reference time for the Reference Tap Timestamp field is illustrated in FIG. 12A. The reference tap offset is illustrated as “a” while the timing offset is illustrated as “b” at the bottom of FIG. 12A. If “a” is equal to zero, i.e., if the reference tap for the partial report is the same as the common reference tap, then the Reference Tap Offset field is absent in the Individual Report Descriptor field. In addition, the Report Parameter Control field as shown in FIG. 12B may also include a reference tap timestamp presence field (corresponding to the above third report field) for indicating the presence of the Reference Tap Timestamp. Besides, the Individual Report Descriptor field as shown in FIG. 12C may also include a reference tap offset presence field (corresponding to the above fourth report field) for indicating the presence of the reference tap offset.

In the second manner, it is also possible that the timestamp of the reference tap is directly signaled separated for each partial report (i.e., a receive antenna—segment pair) in the Reference Tap Timestamp field (corresponding to the above second reference tap timestamp field) in the Individual Report Descriptor field of each Receive Report field, as shown in FIG. 12D. A common point in time known to both the initiator and the responder is used as the reference time for the Reference Tap Timestamp field. For example, the RMARKER of the sensing packet that is used to generate the CIR report may be used as the reference time for the Reference Tap Timestamp field. Or, the start time of the slot in which the sensing packet is transmitted may be used as the reference time. The time unit for both fields is 2⁻⁷ of the 499.2 MHz chipping period, which is approximately 15.65 ps. This is illustrated in FIG. 10C. In addition, the Individual Report Descriptor field as shown in FIG. 12D may also include a reference tap timestamp field (corresponding to the above fifth report field) for indicating the presence of the reference tap timestamp.

It should be noted that in some exemplary figures, although the Receive Report field and the Individual Report Descriptor field are not shown or only some parts of these fields are shown, the above description for the Receive Report field and the Individual Report Descriptor field are applicable for all embodiments of the present disclosure.

As mentioned above, from the perspective of the manner in which the segments or the sensing packets are transmitted, there are three methods for the transmission of the sensing packet: intra-packet frequency stitching, which refers to that different segments of the same sensing packet are transmitted on different channels; inter-packet frequency stitching, which refers to that multiple sensing packets are transmitted on different channels, and different segments of the same sensing packet can be transmitted on different channels or same channel; and combined intra-packet frequency stitching and inter-packet frequency stitching.

From the perspective of the sensing packet used for implementing the first measurement, the at least one first sensing packet in the measurement may include one first sensing packet or multiple first sensing packets. Each first sensing packet may include one segment or multiple segments.

From the perspective of the measurement report frame generated, the at least one first measurement report frame may include one measurement report frame or multiple measurement report frames.

In the following, different cases will be described will be described with reference to corresponding figures.

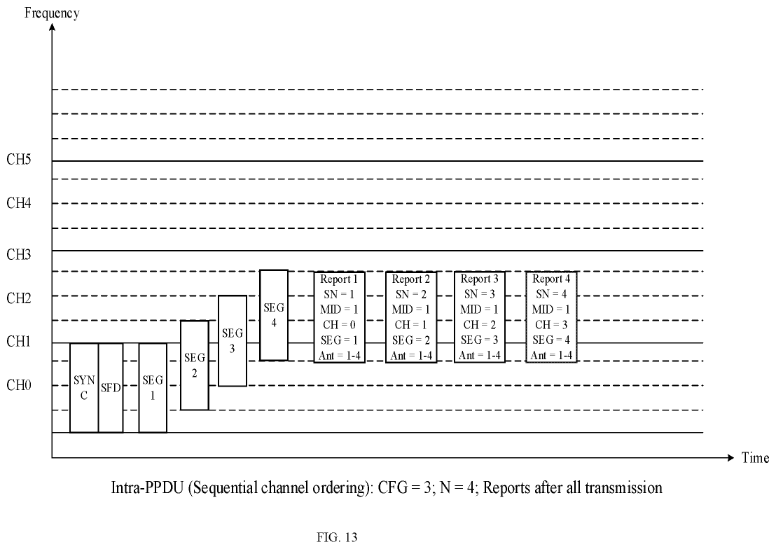

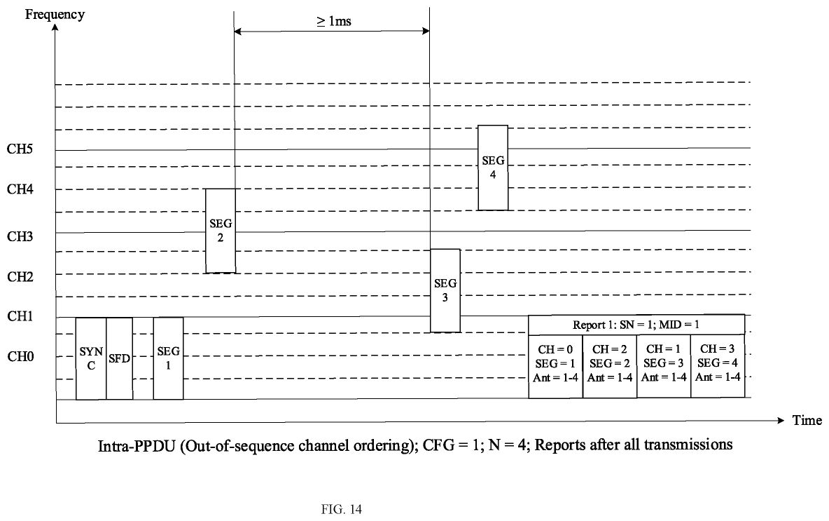

In the communication method according to a possible implementation of the present disclosure, the at least one first sensing packet includes one first sensing packet and the one first sensing packet includes a first preset number of segments; where the at least one first measurement report frame includes multiple measurement report frames, and a number of the multiple measurement report frames is equal to the first preset number; or, where the at least one first measurement report frame includes one measurement report frame. These two different cases are respectively shown in FIG. 13 and FIG. 14 by taking a PPDU with four segments as examples. It should be noted that although the measurement report frame generated in these figures are described with reference to the CIR Report IE format shown in FIG. 9, other formats are also possible for implementing these examples.

As shown in FIG. 13, which is an intra-packet frequency stitching type using sequential transmission, the initiator transmits one first sensing packet to the responder, and the one first sensing packet includes four segments SEG 1, SEG 2, SEG 3 and SEG 4, where the four segments are transmitted on four different channels between CH0 and CH3, inclusive of CH0. The responder transmits four first measurement report frames including Report 1, Report 2, Report 3, and Report 4 according to the one first sensing packet to the initiator. The CFG parameter is set to 3 (75% overlap) and the number of transmissions (N)=4. The Channel Sequence Order field value in AC IE is 0 and the channels used are selected in sequence starting at the base channel. The Frequency Stitching Type field in the AC IE is set as 0 (Intra-packet frequency stitching). The SYNC field, the SFD field and the first segment of the sensing packet are transmitted (by the initiator) on the base channel (CH0) while the segments 2, 3 and 4 are transmitted at carrier frequency increments of 124.8 megahertz (MHz). The responder measures the CIR taps for each segment (at each carrier frequency) using all four of its receive antennas. Four sensing measurement report frames are transmitted by the responder, each sensing measurement report frame carrying the four partial reports corresponding to one segment and four receive antennas. The MID field is set to the same value (e.g., 1) for all four reports, while the Report SN (corresponding to the report number of the first measurement report frame described above) is set in an increasing order. The CH ID field, the Segment ID field and the Rx Antenna field are set to the respective relative channel index, segment and the Rx Antenna used to generate the CIR tap for each partial report. Here, the Channel IDs are relative indices, e.g., CH 0 being the base channel, CH 1 being the next channel that is closest to the base channel etc. The MID field helps to identify the reports of the same measurement and may be used by the initiator (or its sensing applications) to assemble together all the CIR taps corresponding to the same measurement. Similarly, the Report SN field is used for identifying a specific partial report and may be used to solicit selective retransmissions in case of transmission failure. The MID and Report SN are especially useful when the reports are transmitted Out-of-band (OOB) and reports from different measurement instances may arrive at the initiator in a different sequence. Since the Report SN in this example corresponds to four partial reports, so once retransmission is needed, all four partial reports corresponding to the Report SN for which retransmission is needed will be re-transmitted. Here, the measurement report frames are transmitted on the last channel used by the fourth segment of the sensing packet (instead of the base channel). Whether the measurement report frames are transmitted on the base channel or the channel used for the last segment is signaled by the Report channel field of the Frequency Stitching Parameters field in the Sensing Control field of the AC IE. It is set to the last channel in this example.

As shown in FIG. 14, which is an intra-packet frequency stitching type using out-of-sequence transmission, the initiator transmits one first sensing packet to the responder, and the one first sensing packet includes four segments SEG 1, SEG 2, SEG 3 and SEG 4, where the four segments are transmitted on four different channels. The responder transmits one aggregated first measurement report frames according to the one first sensing packet to the initiator. The CFG parameter is set to 1 (25% overlap) and the number of transmissions (N)=4. The Channel Sequence Order field value in AC IE is one and the channels used are selected out of sequence starting at the base channel. The Frequency Stitching Type field in the AC IE is set as 0 (Intra-packet frequency stitching). When out of sequence channel sequence order is used, the overlapping segments are transmitted at least 1 ms apart in order to maximize the transmission power per segment. This may also be signaled explicitly in the MMS Mode field in the AC IE. The SYNC field, the SFD field and the first segment of the sensing packet are transmitted (by the initiator) on the base channel (CH0) while the second segment is transmitted on the third channel, e.g., at carrier frequency increments of two times 374.4 MHz from the base channel. The third segment is transmitted at least 1 millisecond (ms) later at the second channel, e.g., at carrier frequency increments of 374.4 MHz from the base channel while the fourth segments is transmitted on the fourth channel, e.g., at carrier frequency increments of 374.4 MHz from the third channel. The responder measures the CIR taps for each segment (at each carrier frequency) using all four of its receive antennas. In this example the Report channel field of the Frequency Stitching Parameters field in the Sensing Control field of the AC IE is set as 0 (base channel) while the Feedback Control field of the Frequency Stitching Parameters field in the Sensing Control field of the AC IE is set as 1 (Report for all transmission after the last transmission). A measurement report frame is transmitted by the responder on the base channel (CH0) carrying all the partial report for all the channels. Since there are four partial reports corresponding to one segment (one for each receive antenna) and four segments, in total the report frame carries 16 partial reports. The MID field is set to the same value (e.g., 1), while the Report SN is set in an increasing order from the last report frame, if any. The CH ID field, the Segment ID field and the Rx Antenna field are set to the respective channel, segment and the Rx Antenna used to generate the CIR tap for each partial report. In this example, since all the 16 partial reports can fit in the same CIR Report IE, it is also possible that the Report IDs field are omitted and the partial reports included in the Receive Report(s) field may be arranged in a fixed order, e.g., in the sequence of the channel index first, segment index second, and the antenna ID third.

It should be noted that although in FIG. 13, four measurement report frames are generated while in FIG. 14, one measurement report frame is generated, it should be noted that one measurement report frame is also possible for FIG. 13 and multiple measurement report frames are also possible for FIG. 14.

Besides, although in FIG. 13, the sequential transmission manner is adopted, but it is also possible to make a 1 ms time gap between the segments, which is not limited herein. Further, the time gap between different segments may be useful for switching of channels by the initiator, e.g., it may need time to hop to CH1 to transmit SEG2 after transmitting SEG1. Then, the transmission of the measurement report frame(s) on the last channel (the channel on which the last segment is transmitted) shown in FIG. 13 may be beneficial at the responder side, since there is no need for the responder to switch to another channel to transmit the reports, while the transmission of the measurement report frame(s) on the first (base) channel (the channel on which the first SYNC field is transmitted) shown in FIG. 14 may be beneficial at the initiator side, since there is no need for the initiator to switch to another channel to receive the reports. Therefore, in actual applications, different channels for reporting may be chosen based on actual needs.

In the communication method according to a possible implementation of the present disclosure, the at least one first sensing packet includes multiple sensing packets, and the multiple sensing packets are transmitted on different channels, each of the multiple sensing packets includes one or more segments; and segments of the same sensing packet are transmitted on a same channel, or, segments of the same sensing packet are transmitted on different channels.

In a possible implementation, the at least one first measurement report frame includes multiple measurement report frames, and the number of the multiple sensing packets is the same as a number of the multiple measurement report frames.

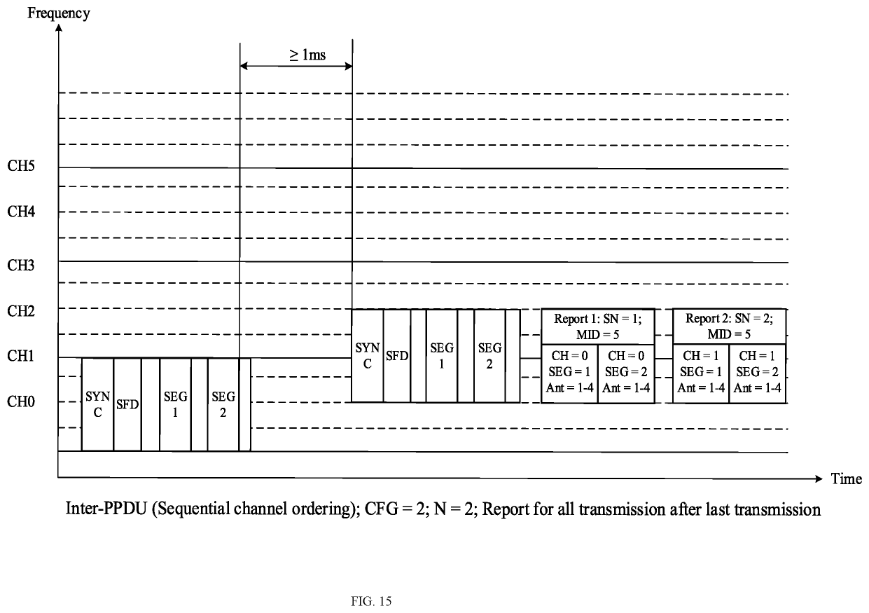

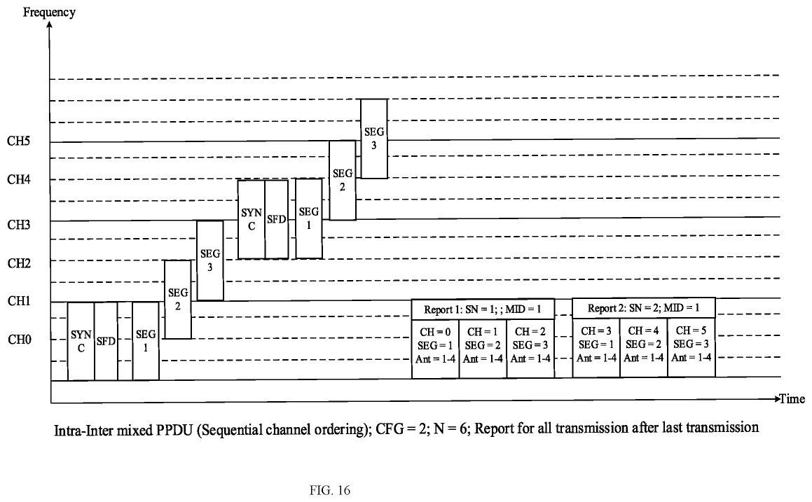

In the following, the communication method according to the above implementations of the present disclosure will be described with reference to FIG. 15 and FIG. 16.

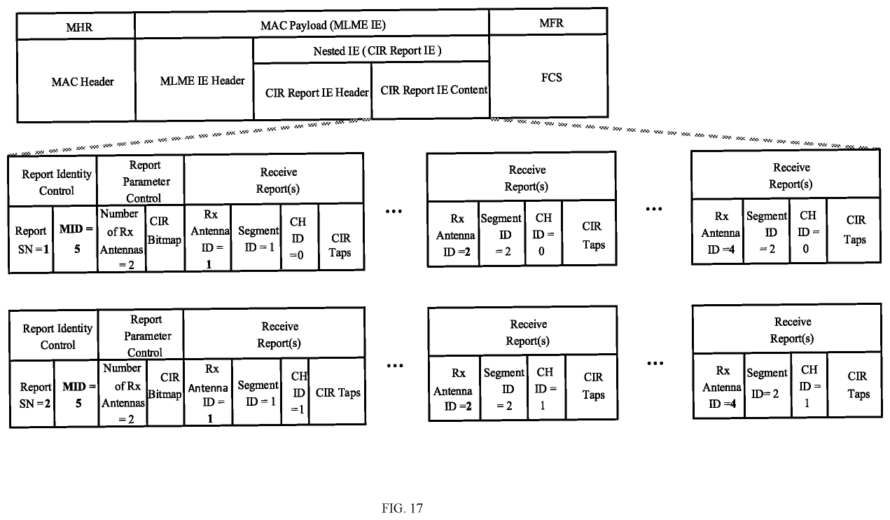

As shown in FIG. 15, which is an inter-packet frequency stitching type using out-of-sequence transmission, the initiator transmits two sensing packets on different channels CH0, CH1 to the responder, and each of the two sensing packets includes two segments SEG 1, SEG2, and the segments of the same sensing packet are transmitted on the same channel. The responder transmits two measurement report frames according to the two sensing packet to the initiator. The CFG parameter is set to 2 (50% overlap) and the number of transmissions (N)=2. The Channel Sequence Order field value in AC IE is 0 and the channels used are selected sequentially starting at the base channel (CH 0). The Frequency Stitching Type field in the AC IE is set as 1 (Inter-packet frequency stitching). Each sensing packet consists of two segments. The first sensing packet is transmitted (by the initiator) on the base channel (CH0) while the second sensing packet is transmitted on the second channel, e.g., at carrier frequency increment of 499.2 MHz from the base channel. Here, the two sensing packets are transmitted at least 1 ms apart in order to maximize the transmission power per transmission. This may also be signaled in the MMS Mode field in the AC IE. The responder measures the CIR taps for each segment (at each carrier frequency) using all four of its receive antennas. In this example the Report channel field of the Frequency Stitching Parameters field in the Sensing Control field of the AC IE is set as 1 (last channel). The Feedback Control field of the Frequency Stitching Parameters field in the Sensing Control field of the AC IE is set as 1 (Report for all transmission after the last transmission). Two sensing measurement report frames are transmitted by the responder on the last channel (CH 1), each frame carrying the partial reports for the individual channels. Since there are four partial reports corresponding to one segment (one for each receive antenna) and two segments, in total each report frame carries 8 partial reports. The MID field is set to the same value (e.g., 5) in both reports, while the Report SNs are set as 1 and 2, respectively. The CH ID field, the Segment ID field and the Rx Antenna field are set to the respective channel, segment and the Rx Antenna used to generate the CIR taps for each partial CIR report. In this example, since all the partial reports are split across two measurement report frames, the Report IDs field in each report can be used to map the CIR Taps to the correct segment. The detailed content of each of the report frames (and CIR Report IE) for the above example is illustrated in FIG. 17. It should be noted that although in FIG. 15, different sensing packets have the same number of segments, but in actual applications, they may have different number of segments. It should be noted that, throughout the text, in specific examples of the format of CIR Report IE, interesting fields are shown, fields that are not shown may also exist in the CIR Report IE.

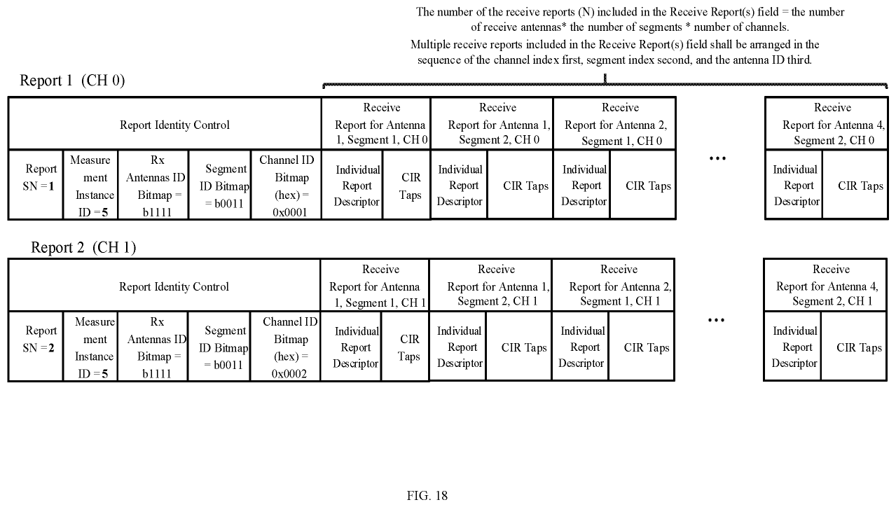

FIG. 18 illustrates the possible contents of the measurement report frame in the example in FIG. 15 using the format of the CIR report IE content field shown in FIG. 10. Two measurement report frames are transmitted by the responder on the last channel (CH1), each frame carrying the partial reports for the individual channels. Since there are four partial reports corresponding to one segment (one for each receive antenna) and two SENS segments, in total each measurement report frame carries 8 partial reports. The MID field is set to the same value (e.g., 5) in both reports, while the Report SNs are set as 1 and 2 respectively. The Rx Antenna ID Bitmap is set as b1111 to indicate that partial reports corresponding to all four receive antennas are present. The Segment ID Bitmap is set as b0011 to indicate that partial Reports corresponding to the first two segments are present. The lowest bit of the Channel ID Bitmap is set to 1 to indicate that the partial reports corresponding to the first channel (CH0) are present in the first report while the second lowest bit of the Channel ID Bitmap is set to 1 in the second report to indicate that the partial reports corresponding to the second channel (CH1) are present in the second report. In each CIR Report IE, multiple receive reports included in the Receive Report(s) field may be arranged in a fixed order, e.g., in the sequence of the antenna ID first and segment index second. In this figure, the number of the receive reports (N) included in the Receive Report(s) filed=the number of receive antenna*the number of segments*the number of channels. In a possible implementation, multiple receive reports included in the Receive Report(s) filed may be arranged in the sequence of the channel index first, segment index second, and the antenna ID third.

As shown in FIG. 16, which is a combination of intra-packet and inter-packet frequency stitching type using sequential transmission, the initiator transmits two sensing packets on different channels to the responder, and each of the two sensing packets includes three segments SEG 1, SEG2 and SEG 3, and the segments of the same sensing packet are transmitted on different channels. The responder transmits two measurement report frames according to the two sensing packets to the initiator. The CFG parameter is set to 2 (50% overlap) and the number of transmissions (N)=6. The Channel Sequence Order field value in AC IE is 0 and the channels used are selected sequentially starting at the base channel (CH 0). The Frequency Stitching Type field in the AC IE is set as 2 (combination of intra-packet and inter-packet frequency stitching). Each sensing packet consists of three segments. The SYNC field, the SFD field and the first segment of the first sensing packet are transmitted (by the initiator) on the base channel (CH0) while the segments 2 and 3 are transmitted, e.g., at carrier frequency increments of 249.6 MHz. Similarly, the SYNC field, the SFD field and the first segment of the second sensing packet are transmitted (by the initiator) on CH3 while the segments 2 and 3 are transmitted, e.g., at carrier frequency increments of 249.6 MHz. The responder measures the CIR taps for each segment (at each carrier frequency) using all four of its receive antennas. In this example the Report channel field of the Frequency Stitching Parameters field in the Sensing Control field of the AC IE is set as 0 (base channel). The Feedback Control field of the Frequency Stitching Parameters field in the Sensing Control field of the AC IE is set as 1 (Report for all transmission after the last transmission). Two sensing measurement report frames are transmitted by the responder on the base channel (CH 0), each frame carrying the partial reports for the individual sensing packets. Since there are four partial reports corresponding to one segment (one for each receive antenna) and 3 segments per sensing packet, in total each measurement report frame carries 12 partial reports. The MID field is set to the same value (e.g., 1) in both reports, while the Report SNs are set as 1 and 2 respectively. The CH ID field, the Segment ID field and the Rx Antenna field are set to the respective channel, segment and the Rx Antenna used to generate the CIR tap for each partial report. In this example, since all the partial reports are split across two sensing measurement report frames, the Report IDs field in each measurement report frame can be used to map the CIR Taps to the correct segment. In both FIG. 15 and FIG. 16, segment with the same index (SEG1 or SEG2) are transmitted in two channels and inclusion of the CH ID field in the report frame is especially beneficial to differentiate the CIR taps for the same segment on different channels.

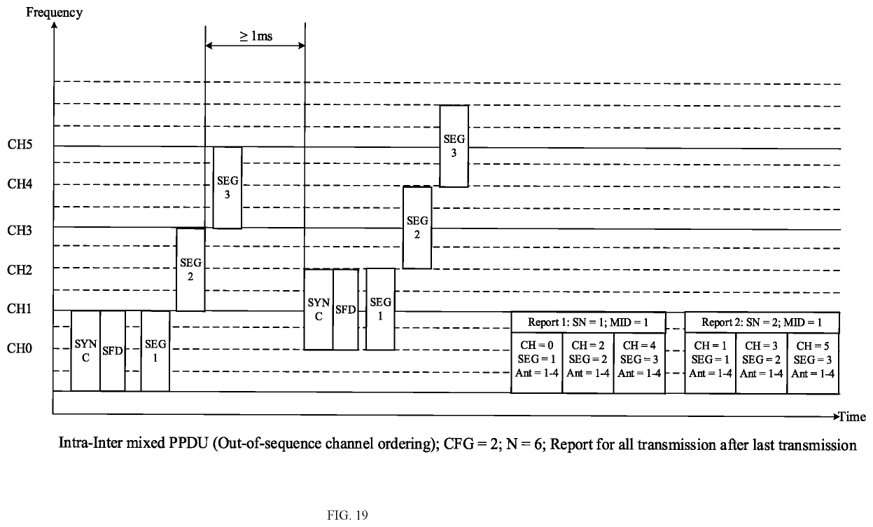

Since there is 50% overlap between transmissions in the example in FIG. 16, the transmission power would need to be limited due to the maximum spectral density requirement. The initiator can overcome this transmit power limitation by choosing the out-of-sequence channel sequence order and ensuring that any two overlapping transmissions are more than 1 ms apart. The example of FIG. 16 utilizing such a transmission sequence is illustrated in FIG. 19.

As shown in FIG. 19, which is a combination of intra-packet and inter-packet frequency stitching type using out-of-sequence transmission, the CFG parameter is set to 2 (50% overlap) and the number of transmissions (N)=6. The Channel Sequence Order field value in AC IE is 1 and the channels used are selected out of sequence starting at the base channel (CH0). The Frequency Stitching Type field in the AC IE is set as 2 (combination of intra-packet and inter-packet frequency stitching). Each sensing packet consists of 3 segments. The SYNC field, the SFD field and the first segment of the first sensing packet are transmitted (by the initiator) on the base channel (CH0) while the segments 2 and 3 are transmitted, e.g., at carrier frequency increments of 499.2 MHz. Here, the two sensing packets are transmitted such that the overlapping transmissions (of the SYNC field, SFD field and SEG1) are at least 1 ms apart in order to maximize the transmission power per transmission. This may also be signaled in the MMS Mode field in the AC IE (as shown in FIG. 7). The SYNC field, the SFD field and the first segment of the second sensing packet are transmitted (by the initiator) on CH 1 at least 1 ms later than the last overlapping transmission (SEG 2 of the first sensing packet on CH2). The segments 2 and 3 of the second sensing packet are transmitted, e.g., at carrier frequency increments of 499.2 MHz. The responder measures the CIR taps for each segment (at each carrier frequency) using all four of its receive antennas. In this example the Report channel field of the Frequency Stitching Parameters field in the Sensing Control field of the AC IE is set as 0 (base channel). The Feedback Control field of the Frequency Stitching Parameters field in the Sensing Control field of the AC IE is set as 1 (Report for all transmission after the last transmission). Two sensing measurement report frames are transmitted by the responder on the base channel (CH 0), each frame carrying the partial reports for the individual sensing packets. Since there are four partial reports corresponding to one segment (one for each receive antenna) and 3 segments per sensing packet, in total each measurement report frame carries 12 partial CIR reports. The MID field is set to the same value (e.g., 1) in both reports, while the Report SNs are set as 1 and 2 respectively. The CH ID field, the Segment ID field and the Rx Antenna field are set to the respective channel, segment and the Rx Antenna used to generate the CIR tap for each partial report. In this example, since all the partial reports are split across two measurement report frames, the Report IDs field in each report can be used to map the CIR Taps to the correct segment.

In the communication method according to a possible implementation of the present disclosure, in a case where the segments of the same sensing packet are transmitted on the same channel, the at least one first measurement report frame includes one measurement report frame, and the one measurement report frame is indicative of the first reporting set corresponding to the respective partial report, where measurements for each segment are reported for aggregation of the different channels on which the multiple sensing packets are transmitted.

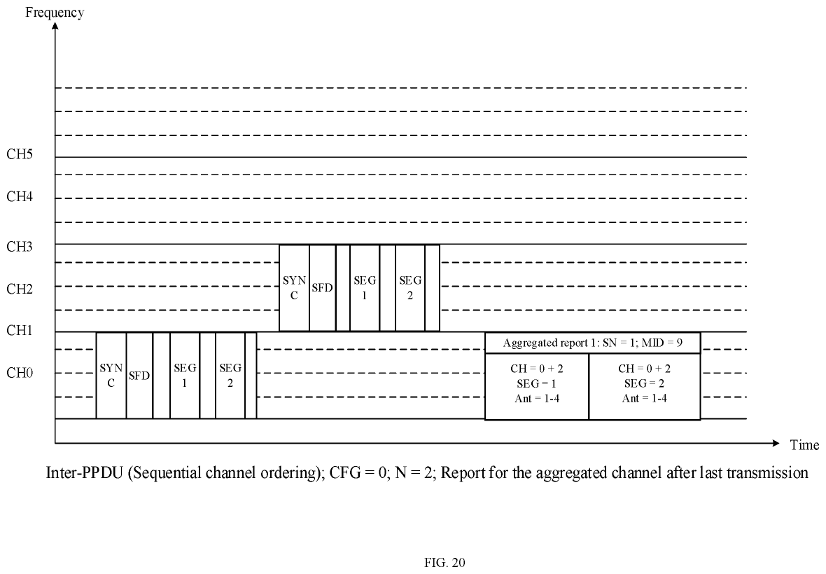

In the following, the communication method according to the above implementations of the present disclosure will be described with reference to FIG. 20.

As shown in FIG. 20, the initiator transmits two sensing packets on different channels to the responder, and each of the two sensing packets includes two segments SEG 1, SEG2, and the segments of the same sensing packet are transmitted on the same channel. The responder transmits one aggregated measurement report frame according to the two sensing packets to the initiator. The CFG parameter is set to 0 (no overlap) and the number of transmissions (N)=2. The channel sequence order field value in AC IE is one and the channels used are selected sequentially starting at the base channel. The frequency stitching type field in the AC IE is set as 1 (Inter-packet frequency stitching). Each sensing packet consists of two segments. The first sensing packet is transmitted (by the initiator) on the base channel (CH0) while the second sensing packet is transmitted on the second channel, e.g., at carrier frequency increment of 499.2 megahertz (MHz) from the base channel. The responder measures the CIR taps for each segment (at each carrier frequency) using all four of its receive antennas. In this example the Report channel field of the frequency stitching parameters field in the sensing control field of the AC IE is set as 0 (base channel) while the feedback control field of the frequency stitching parameters field in the sensing control field of the AC IE is set as 1 (report for aggregated channel after the last transmission). A measurement report frame is transmitted by the responder on the base channel (CH0) carrying all the partial report for the aggregated channels. In this case, the CIR taps for each segment are combined across the channels (CH 0 and CH 2). Since there are four partial reports corresponding to one segment (one for each receive antenna) and two segments, in total the report frame carries 8 partial reports. The MID field is set to the same value (e.g., 9), while the report SN is set in an increasing order from the last report frame, if any. The Segment ID field and the Rx antenna field are set to the respective segment and the Rx antenna used to generate the CIR tap for each partial CIR report but since the channels are aggregated, i.e., the CIR taps are measured for the total channel comprising the sum of CH0 and CH2, the CH ID field is reserved in this case. In this example, since all the 8 partial reports can fit in the same CIR report IE, the report IDs field may be omitted and the partial CIR reports included in the receive report(s) field may be arranged in a fixed order, e.g., in the sequence of the segment index first, and the antenna ID second. When a report is sent for the aggregated channel, it is also possible that a larger CIR bitmap may be used (compared to the case when separate report is sent for each channel). It can be seen that the aggregated report is generated, where the measurements on CH0 and CH1 for SEG1 are combined by the responder, and measurements on CH0 and CH1 for SEG2 are also combined by the responder. Therefore, in the report here, measurements for each segment are reported for aggregation of the different channels (CH0 and CH1) on which the multiple sensing packets are transmitted. Although not shown in any of FIG. 9, FIG. 10 or FIG. 11, when the measurement report is for the aggregated channel, a bit in the report (e.g., an Aggregated Channel bit in the report parameter control field) in the report IE in FIG. 9, FIG. 10 or FIG. 11 is set to 1 to alert the initiator that the measurement report is for the aggregated channel.

The transmission of multiple sensing packets for implementing the same measurement purpose (sensing task) would be beneficial in the case where the number of segments is limited. For example, in the above example shown in FIG. 19, now the sensing task is to measure the conditions of CH0 to CH5, since the maximum number of segments may be limited to four, then, if we simply transmit the four segments on these channels, even each segment occupies one channel, it seems to be difficult to sense all the six channels, so in this case, we may choose to transmit two sensing packets, each sensing packet may be further segmented, in this way, all the six channels will have segments transmitted thereon, and the sensing task would be accomplished accordingly.

It should be noted that in all the examples shown above, the specific values (e.g., MID, report SN) for fields are simply for illustration purposes, and there is no limitation for these values. Besides, throughout the text, in specific examples of the format of CIR report IE, interesting fields are shown, fields that are not shown may also exist in the CIR report IE.

The above examples are not only applicable for the process shown in FIG. 6B, but are also applicable for the case of multiple responders. In the case of multiple responders, for the behaviors of each responder, as well as the measurement report frame used by each responder for reporting the result of the measurement, reference could be made to the above examples. In the following, the process of the interaction between an initiator and multiple responders will be described with reference to corresponding flowcharts.

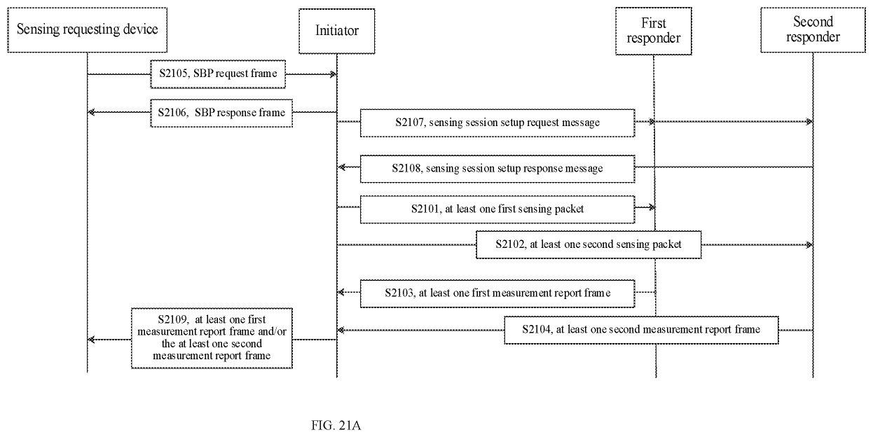

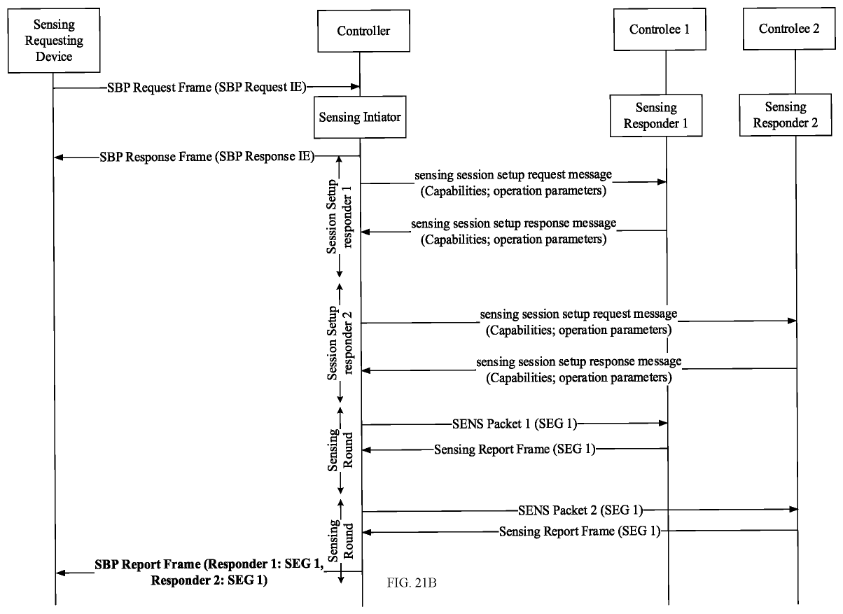

FIG. 21A is a flowchart of a communication method provided by an embodiment of the present application. As shown in FIG. 21A, the method may include the following steps.

The present disclosure provides another communication method involving the interaction between a sensing requesting device, an initiator (proxy), and multiple responders, applied for ultra-wideband sensing of proxy (SBP) scenario. Reference may be made to FIG. 21B, the communication method may include the following steps.
S2101, an initiator transmits at least one first sensing packet to a first responder, and the first responder receives the at least one first sensing packet.
S2102, the initiator transmits at least one second sensing packet to a second responder, and the second responder receives the at least one second sensing packet.

The transmission of the first sensing packet and the second sensing packet is as same as the transmission of the first sensing packet shown in FIG. 6A. The behavior of the second responder is as same as those of the first responder. Reference may be made to the relevant part in FIG. 6A for detailed description. It should be noted that in this process, the first responder can also be referred to as a responder, and the second responder can also be referred to as a further responder, here we use the first responder and second responder just for the sake of clarity.
S2103, the first responder transmits at least one first measurement report frame according to the at least one first sensing packet to the initiator, and the initiator receives the at least one first measurement report frame.
S2104, the second responder transmits at least one second measurement report frame according to the at least one second sensing packet to the initiator, and the initiator receives the at least one second measurement report frame.

Further, the at least one first measurement report frame is used to provide a result of first measurement carried by the responder on the at least one first sensing packet, and a respective first measurement report frame of the at least one first measurement report frame is indicative of the respective first measurement report frame and the first measurement to which the at least one first sensing packet belongs. The at least one second measurement report frame is used to provide a result of second measurement carried by the further responder on the at least one second sensing packet, and a respective second measurement report frame of the at least one second measurement report frame is indicative of the respective second measurement report frame and the second measurement to which the at least one second sensing packet belongs.

Here the second sensing packet, the second measurement report frame, the second measurement related to the second responder are similar to the first sensing packet, the first measurement report frame, the first measurement related to the first responder, except that the names of the responders are different for distinguishing purpose. Details will not be elaborated herein for brevity.

As mentioned above, the behavior of second responder is as same as those of the first responder, so reference may be made to the relevant part in FIG. 6A for detailed description.

Here, the initiator is a controller which assumes the role of initiator. The first responder and the second responder are assumed as two controlees, shown as controlee 1 and controlee 2 in the figure.

In a possible implementation of the present disclosure, before the initiator transmits the at least one first sensing packet to the multiple responders in S2101, the method further includes the following steps.
S2105, a sensing requesting device transmits an SBP request frame to the initiator, where the SBP request frame is used for requesting1 the initiator to perform sensing with the first responder and the second responder on its behalf.

In a possible implementation, the SBP request frame here may carry an SBP request IE.
S2106, the initiator transmits an SBP response frame to the sensing requesting device according to the SBP request frame.

In a possible implementation, the SBP response frame here may carry an SBP response IE.
S2107, the initiator transmits a sensing session setup request message to the first responder and the second responder.
S2108, the initiator receives sensing session setup response messages from the first responder and the second responder respectively, where the sensing session setup response messages are determined by the first responder and the second responder according to the sensing session setup request message.

In a possible implementation of the present disclosure, after receiving the at least one first measurement report frame and the at least one second measurement report frame from the first responder and the second responder, the initiator may process these measurement report frames so as to forward the measurement results of these responders to the sensing requesting device. That is, the method may further include the following steps.
S2109, the initiator forwards the at least one first measurement report frame and/or the at least one second measurement report frame to a sensing requesting device. The two report frames may also be combined as a single report frame carrying two CIR report IEs.

Further, upon receiving the at least one first measurement report frame and the at least one second measurement report frame, the initiator may forward both of the measurement report frames to the sensing requesting device, or may simply forward one of them to the sensing requesting device, depending on actual needs.

Here the forwarding may be direct forwarding without processing, or may also be forwarding of processed measurement report frames.

In a possible implementation of the present disclosure, the forwarding of the at least one first measurement report frame and/or the at least one second measurement report frame to the sensing requesting device includes: for each of the at least one first measurement report frame and/or the at least one second measurement report frame, the initiator processing the measurement report frame to meet an address requirement, where the address requirement includes a measurement report frame carrying an address of a responder transmitting the measurement report frame, where the address of the responder is readable by the sensing requesting device; and forwarding the processed measurement report frame to a sensing requesting device.

As mentioned above with reference to specific formats of reports, the responder address field may be included for indicating the address of a responder transmitting the measurement report frame. The address identifier for identifying the address of the responder may be carried in the Responder Address field shown in the above figures, and a sixth report field may also be included for indicating whether the address identifier is present.

In order to reduce overhead, the address of the responder indicated by the measurement report frame may be a short address, this short address is readable by the initiator but may be unreadable by the sensing requesting device, so the initiator needs to replace such short address with an extended address which could be read by the sensing requesting device. In another case, the responder address field may also be omitted, that is, there is no responder address field in the measurement report frame from the responder, then in this case, the initiator would have to add the address of the responder so as to let the sensing requesting device knows the address of the responder. If the sensing requesting device is also part of the same network as the sensing responder, the address could be a short address, else it may be an extended address. Therefore, the initiator may process the received measurement report frame (the at least one first measurement report frame and the at least one second measurement report frame) so as to ensure that they meet the above address requirement.

In a possible implementation of the present disclosure, the processing of the measurement report frame to meet an address requirement includes: in a case that the measurement report frame does not carry a first address (the short address mentioned above), the initiator adding a second address (the extended address mentioned above) to the first measurement report frame; and in a case that the measurement report frame carries the first address, the initiator replacing the first address with the second address, where the first address and the second address are addresses of a responder transmitting the measurement report frame, the first address is unreadable by the sensing requesting device and the second address is readable by the sensing requesting device.

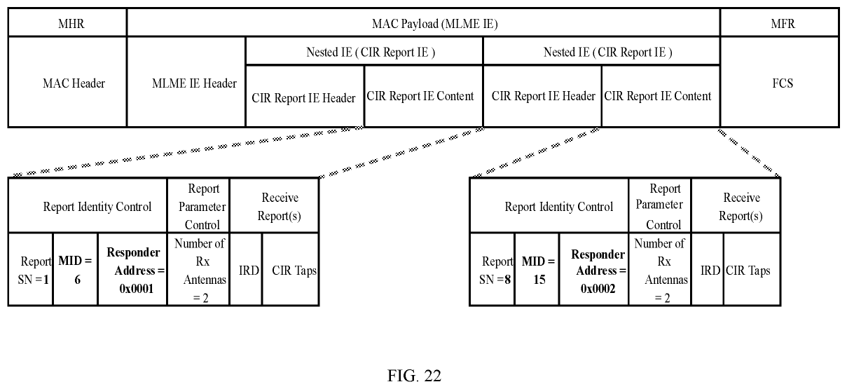

In the following, an example of the above process will be described in detail with reference to FIG. 21B. An overview of the message exchange for the sensing by proxy (SBP) scenario, between a sensing requesting device, a sensing initiator and two sensing responders is illustrated in FIG. 21B. The process starts when the sensing requesting device transmits an SBP Request frame carrying an SBP request IE to a Controller device requesting it to perform sensing with two other responders on its behalf. The controller assumes the role of initiator and during the session setup phases, transmits a sensing session setup request message to two selected controlees, assigning them the role of responders and also specifying initiator's sensing capabilities. Each of the session setup request message also includes an AC IE carrying the parameters related to sensing as well as operation parameters (here the AC IE may be in the format shown in FIG. 7). Each responder responds with a sensing session setup response message carrying its sensing capabilities as well as operating parameters. Subsequently in a first sensing round, the initiator transmits a sensing packet with one or more segment to responder 1. Upon receiving the sensing packet, the responder 1 measures the CIR taps for each of the bit set to 1 in the CIR bitmap field of the AC IE. A partial report is generated for each of the pair made up of the responder's receive antenna and segment of the sensing packet and the responder 1 transmits a measurement report frame carrying the partial reports to the initiator. Similarly, in the second sensing round, the initiator transmits a sensing packet with one or more segment to responder 2. Upon receiving the sensing packet, the responder 2 measures the CIR taps for each of the bit set to 1 in the CIR bitmap field of the AC IE. A partial report is generated for each of the pair made up of the responder's receive antenna and segment of the sensing packet and the responder 2 transmits a measurement report frame carrying the partial reports to the initiator. The initiator may simply forward the CIR report(s) obtained from each of the responders to the sensing requesting device in individual SBP report frames, or it may also choose to consolidate the CIR reports from both the responders in a single SBP Report frame as illustrated in FIG. 20. An example of an SBP report frame carrying the CIR reports from two responders is illustrated in FIG. 22. The initiator may extract the CIR report IE received from each of the responders and place them together in the same SBP report frame one after another. In other to help the sensing requesting device to identify the source of the CIR reports, if not already present in the CIR report IE, the initiator also adds the responder address field carrying the extended MAC address of the responder in the report identity control field of each of the CIR report IE. The report SN and the MID in the two CIR report IE is specific to a responder and may be different in the two IEs.

It should be understood that the solution of the present disclosure is also applicable for the case where there are more than two responders, although the case where there are two responders is illustrated in the description.

Next, embodiments of products related to the wireless communication methods will be described.

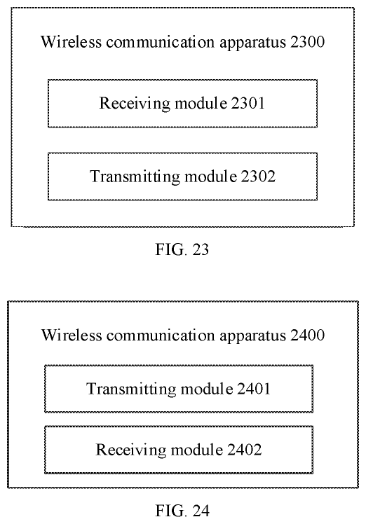

FIG. 23 shows a schematic structural diagram of a wireless communication apparatus according to an embodiment of the present disclosure. As shown in FIG. 23, the wireless communication apparatus 2300 may include a receiving module 2301 configured to receive at least one first sensing packet from an initiator; and a transmitting module 2302, configured to transmit at least one first measurement report frame according to the at least one first sensing packet, where the at least one first measurement report frame is used to provide a result of first measurement performed by the responder on the at least one first sensing packet, and a respective first measurement report frame of the at least one first measurement report frame is indicative of an identification of the respective first measurement report frame and the first measurement to which the at least one first sensing packet belongs.

In a possible implementation, the respective first measurement report frame includes a report number for indicating the identification of the first measurement report frame and a measurement number for identifying the first measurement to which the at least one first sensing packet belongs.

In a possible implementation, the at least one first sensing packet includes one or more segments, and the respective first measurement report frame includes at least one partial report; where a respective partial report of the at least one partial report corresponds to a first reporting set of a segment of the at least one first sensing packet and an antenna of the responder for receiving the segment.

In a possible implementation, the respective partial report corresponds to a second reporting set of the segment of the at least one first sensing packet, the antenna of the responder for receiving the segment and a first channel on which the segment is transmitted by the initiator.

In a possible implementation, the respective partial report is indicative of the second reporting set corresponding to the respective partial report.

In a possible implementation, the respective partial report includes a segment identifier for identifying the segment in the second reporting set corresponding to the respective partial report, an antenna identifier for identifying the antenna in the second reporting set corresponding to the respective partial report and a channel identifier for identifying the first channel in the second reporting set corresponding to the respective partial report.

In a possible implementation, the respective first measurement report frame further includes a first report field for indicating whether the segment identifier, the antenna identifier and the channel identifier are present.

In a possible implementation, the channel identifier is a relative index of the first channel on which the segment is transmitted by the initiator.

In a possible implementation, the respective first measurement report frame includes a segment bitmap for identifying the segment in the second reporting set corresponding to the respective partial report, an antenna bitmap for identifying the antenna in the second reporting set corresponding to the respective partial report and a channel bitmap for identifying the channel in the second reporting set corresponding to the respective partial report.

In a possible implementation, the respective first measurement report frame further includes a second report field for indicating whether the segment bitmap, the antenna bitmap and the channel bitmap are present.

In a possible implementation, the at least one partial report includes multiple partial reports, and the multiple partial reports are arranged in a preset order.

In a possible implementation, where the at least one first sensing packet includes one first sensing packet and the one first sensing packet includes a first preset number of segments; where the at least one first measurement report frame includes multiple measurement report frames, and a number of the multiple measurement report frames is equal to the first preset number; or, where the at least one first measurement report frame includes one measurement report frame.

In a possible implementation, the first preset number of segments are transmitted on different channels.

In a possible implementation, the at least one first sensing packet includes multiple sensing packets, and the multiple sensing packets are transmitted on different channels, each of the multiple sensing packets includes one or more segments; where segments of a same sensing packet are transmitted on a same channel, or, segments of a same sensing packet are transmitted on different channels.

In a possible implementation, the at least one first measurement report frame includes multiple measurement report frames, and a number of the multiple sensing packets is the same as a number of the multiple measurement report frames.

In a possible implementation, in a case where the segments of the same sensing packet are transmitted on the same channel, the at least one first measurement report frame includes one measurement report frame, and the one measurement report frame is indicative of the first reporting set corresponding to the respective partial report, where measurements for each segment are reported for aggregation of the different channels on which the multiple sensing packets are transmitted.

In a possible implementation, the respective first measurement report frame is further indicative of a first reference tap timestamp for all of the at least one partial report.

In a possible implementation, the respective first measurement report frame includes a first reference tap timestamp field for indicating the first reference tap timestamp.

In a possible implementation, the respective first measurement report frame further includes a third report field for indicating whether the first reference tap timestamp field is present.

In a possible implementation, the respective partial report is indicative of an offset between the first reference tap timestamp and a second reference tap timestamp for the respective partial report.

In a possible implementation, the respective partial report includes an offset field for indicating the offset between the first reference tap timestamp and the second reference tap timestamp for the respective partial report.

In a possible implementation, the respective partial report further includes a fourth report field for indicating whether the offset field is present.

In a possible implementation, the respective partial report is indicative of a second reference tap timestamp for the respective partial report.

In a possible implementation, the respective partial report includes a second reference tap timestamp field for indicating the second reference tap timestamp for the respective partial report.

In a possible implementation, the respective partial report further includes a fifth report field for indicating whether the second reference tap timestamp field is present.

In a possible implementation, a first measurement report frame of the at least one first measurement report frame is indicative of a first parameter for all partial reports carried in the at least one first measurement report frame, and indications for the first parameter are omitted in remaining measurement report frames other than the first measurement report frame.

In a possible implementation, the respective first measurement report frame is further indicative of an address of the responder.

In a possible implementation, the respective first measurement report frame includes an address identifier for identifying the address of the responder.

In a possible implementation, the respective first measurement report frame further includes a sixth report field for indicating whether the address identifier is present.

In a possible implementation, a first sensing packet in the at least one first sensing packet includes multiple segments, and the multiple segments are transmitted in a sequential manner or an out-of-sequence manner.

In a possible implementation, the receiving module 2301 is further configured to receive a sensing session setup request message from the initiator, where the sensing session setup request message is indicative of a second channel for transmitting the at least one first measurement report frame; and the transmitting module 2302 is further configured to transmit a sensing session setup response message to the initiator according to the sensing session setup request message; transmit the at least one first measurement report frame according to the at least one sensing packet over the second channel.

In a possible implementation, the sensing session setup request message is further indicative of a time requirement between two overlapped segments of a sensing packet or two overlapped sensing packets.

The communication apparatus may be applied to the responder as described in the above method embodiments or may be the responder as described in the above method embodiments. It should be understood by a person skilled in the art that the relevant description of the above modules in the embodiments of the present disclosure may be understood with reference to the relevant description of the communication method in the embodiments of the present disclosure.

FIG. 24 shows a schematic structural diagram of a wireless communication apparatus according to an embodiment of the present disclosure. As shown in FIG. 24, the wireless communication apparatus 2400 may include a transmitting module 2401 configured to transmit at least one first sensing packet to a responder; and a receiving module 2402 configured to receive at least one first measurement report frame from the responder, where the at least one first measurement report frame is used to provide a result of first measurement carried by the responder on the at least one first sensing packet, and a respective first measurement report frame of the at least one first measurement report frame is indicative of the respective first measurement report frame and the first measurement to which the at least one first sensing packet belongs.

In a possible implementation, the transmitting module 2401 is further configured to transmit a sensing session setup request message to the responder, where the sensing session setup request message is indicative of a second channel for transmitting the at least one first measurement report frame; and the receiving module 2402 is further configured to receive a sensing session setup response message from the responder, where the sensing session setup response message is determined by the responder according to the sensing session setup request message.

In a possible implementation, the sensing session setup request message is further indicative of a time requirement between two overlapped segments of a first sensing packet or two overlapped first sensing packets.

In a possible implementation, the transmitting module 2401 is further configured to transmit at least one second sensing packet to a further responder; and the receiving module 2402 is further configured to receive at least one second measurement report frame from the further responder, where the at least one second measurement report frame is used to provide a result of second measurement carried by the further responder on the at least one second sensing packet, and a respective second measurement report frame of the at least one second measurement report frame is indicative of the respective second measurement report frame and the second measurement to which the at least one second sensing packet belongs.

In a possible implementation, the transmitting module 2401 is further configured to forward the at least one first measurement report frame and/or the at least one second measurement report frame to a sensing requesting device.

In a possible implementation, the communication apparatus further includes a processing module configured to: for each of the at least one first measurement report frame and/or the at least one second measurement report frame, process the measurement report frame to meet an address requirement, where the address requirement includes a measurement report frame carrying an address of a responder transmitting the measurement report frame, where the address of the responder is readable by the sensing requesting device; the transmitting module 2401 is further configured to forward the processed measurement report frame to a sensing requesting device.

In a possible implementation, the processing module is further configured to: in a case that the measurement report frame does not carry a first address, add a second address to the first measurement report frame; and in a case that the measurement report frame carries the first address, replace the first address with the second address; where the first address and the second address are addresses of a responder transmitting the measurement report frame, the first address is unreadable by the sensing requesting device and the second address is readable by the sensing requesting device.

The communication apparatus may be applied to the initiator as described in the above method embodiments or may be the initiator as described in the above method embodiments. It should be understood by a person skilled in the art that the relevant description of the above modules in the embodiments of the present disclosure may be understood with reference to the relevant description of the communication method in the embodiments of the present disclosure.

An embodiment of the present disclosure provides a terminal device including processing circuitry for executing any of the above wireless communication methods. It should be understood that the terminal device can execute the steps performed by the terminal device in the above method embodiments, which will not be repeated here.

An embodiment of the present disclosure provides a network device including processing circuitry for executing any of the above wireless communication methods. It should be understood that the network device can execute the steps performed by the network device in the above method embodiments, which will not be repeated here.

An embodiment of the present disclosure provides a wireless communication apparatus which includes a processor and a memory. The memory is storing instructions that cause the processor to perform any of the above wireless communication methods.

An embodiment of the present disclosure provides a wireless communication system, including a network device and a terminal device. The terminal device is configured to execute the steps executed by the terminal device in any of the above wireless communication methods, and the network device is configured to execute the steps executed by the network device in any of the above wireless communication methods.

An embodiment of the present disclosure provides a computer-readable medium storing computer execution instructions which, when executed by a processor, causes the processor to execute any of the above wireless communication methods.

An embodiment of the present disclosure provides a computer program product including computer execution instructions which, when executed by a processor, causes the processor to execute any of the above wireless communication methods.

Although the present disclosure describes methods and processes with steps in a certain order, one or more steps of the methods and processes may be omitted or altered as appropriate. One or more steps may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including digital versatile discs (DVDs), compact disc (CD)-ROMs, Universal Serial Bus (USB) flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may include a specific number of elements/components, the systems, devices, and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

Although embodiments have been described above with reference to the accompanying drawings, those of skill in the art will appreciate that variations and modifications may be made without departing from the scope thereof as defined by the appended claims.

1. A method implemented by a responder, wherein the method comprises:
receiving, from an initiator, at least one sensing packet; and
transmitting, based on the at least one sensing packet, at least one measurement report frame, and
wherein a respective measurement report frame of the at least one measurement report frame comprises at least one partial report,
wherein a respective partial report of the at least one partial report comprises a segment identifier identifying a segment corresponding to the respective partial report, an antenna identifier identifying an antenna corresponding to the respective partial report, and a channel identifier identifying a channel corresponding to the respective partial report.

2. The method of claim 1, wherein the channel is a channel on which the segment is transmitted by the initiator.

3. The method of claim 1, wherein the at least one sensing packet comprises one or more segments, and wherein the respective partial report corresponds to the segment and the antenna.

4. The method of claim 1, wherein the respective measurement report frame further comprises a report identity control field, a report parameters control field, and a receive report field, and wherein the receive report field comprises the at least one partial report.

5. The method of claim 4, wherein the report identity control field comprises a responder address mode field, a measurement identifier (ID) field, and a responder address field, wherein the responder address mode field indicates a presence and a size of the responder address field, wherein the measurement ID field identifies a sensing measurement instance, and wherein the responder address comprises an address identifier identifying the responder.

6. The method of claim 4, wherein the report parameters control field comprises a number of receive (Rx) antennas field, a bitmap length field, a bitmap offset field, a number of segments field, a compression field, and a channel impulse response (CIR) bitmap field.

7. The method of claim 1, wherein the respective partial report further comprises report IDs field, an individual report descriptor field, and a channel impulse response (CIR) tape field, wherein the report IDs field comprises the segment identifier, the antenna identifier, and the channel identifier, wherein the CIR taps field comprises CIR tap values, and wherein each of the CIR tap values for each bit in a CIR bitmap is set to one.

8. The method of claim 7, wherein the individual report descriptor field comprises a timing offset field, a normalization factor field, and received signal strength indicator (RSSI) information, wherein the timing offset field indicates a time offset between a reference tap and a timing grid of the respective partial report, wherein the normalization factor field indicates a normalization factor applied to the CIR taps values, and wherein the RSSI information indicates a received signal strength at the antenna.

9. The method of claim 1, wherein the at least one partial report comprises multiple partial reports arranged in a preset order.

10. An apparatus comprising:
at least one memory configured to store instructions; and
at least one processor coupled to the at least one memory and configured to execute the instructions to cause the apparatus to:
receive, from an initiator, at least one sensing packet; and
transmit, based on the at least one sensing packet, at least one measurement report frame
wherein a respective measurement report frame of the at least one measurement report frame comprises at least one partial report, and
wherein a respective partial report the of at least one partial report comprises a segment identifier identifying a segment corresponding to the respective partial report, an antenna identifier identifying an antenna corresponding to the respective partial report, and a channel identifier identifying a channel corresponding to the respective partial report.

11. The apparatus of claim 10, wherein the channel is a channel on which the segment is transmitted by the initiator.

12. The apparatus of claim 10, wherein the at least one sensing packet comprises one or more segments, and wherein the respective partial report corresponds to the segment and the antenna.

13. The apparatus of claim 10, wherein the respective first measurement report frame further comprises a report identity control field, a report parameters control field, and a receive report field, and wherein the receive report field comprises the at least one partial report.

14. The apparatus of claim 13, wherein the report identity control field comprises responder address mode field, a measurement identifier (ID) field, and a responder address field, wherein the responder address mode field indicates a presence and a size of the responder address field, wherein the measurement ID field identifies a sensing measurement instance, and wherein the responder address field comprises an address identifier identifying the apparatus.

15. The apparatus of claim 13, wherein the report parameters control field comprises a number of receive (Rx) antennas field, a bitmap length field, a bitmap offset field, a number of segments field, a compression field, and a channel impulse response (CIR) bitmap field.

16. The apparatus of claim 10, wherein the respective partial report further comprises report IDs field, an individual report descriptor field, and a channel impulse response (CIR) taps field, wherein the report IDs field comprises the segment identifier, the antenna identifier and the channel identifier, wherein the CIR taps field comprises CIR tap values, and wherein each of the CIR tap values for each bit in a CIR bitmap is set to one.

17. The apparatus of claim 16, wherein the individual report descriptor field comprises a timing offset field, a normalization factor field, and received signal strength indicator (RSSD) information, wherein the timing offset field indicates a time offset between a reference tap and a timing grid of the respective partial report, wherein the normalization factor field indicates a normalization factor applied to the CIR taps values, and wherein the RSSI information indicates a received signal strength at the antenna.

18. The apparatus of claim 10, wherein the at least one partial report comprises multiple partial reports arranged in a preset order.

19. A computer program product comprising computer-executable instructions that are stored on a non-transitory computer-readable storage medium and that, when executed by at least one processor, cause an apparatus to:
receive, from an initiator, at least one sensing packet; and
transmit, based on the at least one sensing packet, at least one measurement report frame, wherein
a respective measurement report frame of the at least one measurement report frame comprises at least one partial report, and
wherein a respective partial report of the at least one partial report comprises a segment identifier identifying a segment corresponding to the respective partial report, an antenna identifier identifying an antenna corresponding to the respective partial report, and a channel identifier identifying a channel corresponding to the respective partial report.

20. The computer program product of claim 19, wherein the channel is a channel on which the segment is transmitted by the initiator.
